(19) United States
(12) Patent Application Publication
(10) Pub. No.: US 2025/0310163 A1
(43) Pub. Date: Oct. 2, 2025

(54) GUARD INTERVAL (GI)-BASED INTEGRATED SENSING AND COMMUNICATIONS (ISAC) WAVEFORM

(71) Applicant: QUALCOMM Incorporated, San Diego, CA (US)

(72) Inventors: Preeti KUMARI, San Diego, CA (US); Weimin DUAN, San Diego, CA (US); Juergen CEZANNE, Ocean Township, NJ (US)

(21) Appl. No.: 18/624,473

(22) Filed: Apr. 2, 2024

(51) Int. Cl. H04L 27/26; H04W 24/08

(52) U.S. Cl. CPC H04L 27/2607; H04W 24/08

(57) ABSTRACT

In some implementations, a wireless device may perform integrated radio frequency (RF) sensing and communications by receiving a guard interval integrated sensing and communications (GI-ISAC) configuration at the wireless device from a configuring node of a wireless network, where the GI-ISAC configuration is indicative of a set of one or more parameters describing characteristics of a GI-ISAC waveform to be used by the wireless device for RF sensing, and where the set of one or more parameters describing characteristics of the GI-ISAC waveform is based at least in part on orthogonal frequency division multiplexing (OFDM) communication data symbols used by the wireless network. In addition, the wireless device may perform an RF sensing function with the wireless device in accordance with the GI-ISAC configuration.

### TECHNICAL FIELD

The present disclosure relates generally to the field of radio frequency (RF) sensing, and more specifically to RF sensing in a wireless network.

### BACKGROUND

The performance of RF sensing by wireless devices can have a wide range of consumer, industrial, commercial, and other applications. RF sensing can be used to determine the presence of a target object, determine the location of the target object, and/or track the movement of the target object over time. Cellular networks (e.g., fifth-generation (5G) new radio (NR) networks) and other types of wireless networks may be capable of performing RF sensing using base stations, user equipments (UEs), and/or other wireless devices communicatively coupled with the cellular network as “sensing nodes.” Traditional cellular networks operate using an orthogonal frequency-division multiplexing (OFDM) communication scheme that utilizes a cyclic prefix (CP), which may be referred to as CP-OFDM.

### BRIEF SUMMARY

An example method at a wireless device of performing integrated radio frequency (RF) sensing and communications, according to this description, may include receiving a guard interval integrated sensing and communications (GI-ISAC) configuration at the wireless device from a configuring node of a wireless network, where the GI-ISAC configuration is indicative of a set of one or more parameters describing characteristics of a GI-ISAC waveform to be used by the wireless device for RF sensing, where the set of one or more parameters describing characteristics of the GI-ISAC waveform is based at least in part on orthogonal frequency division multiplexing (OFDM) communication data symbols used by the wireless network. The method may also include performing an RF sensing function with the wireless device in accordance with the GI-ISAC configuration.

An example method at a configuring node of a wireless network of enabling integrated radio frequency (RF) sensing and communications, according to this description, may include determining a guard interval integrated sensing and communications (GI-ISAC) configuration, where the GI-ISAC configuration is indicative of a set of one or more parameters describing characteristics of a GI-ISAC waveform to be used by a wireless device to perform an RF sensing function, where the set of one or more parameters describing characteristics of the GI-ISAC waveform is based at least in part on orthogonal frequency division multiplexing (OFDM) communication data symbols used by the wireless network. The method may also include sending the GI-ISAC configuration to the wireless device.

An example wireless device, according to this description, may include one or more transceivers, one or more memories, and one or more processors communicatively coupled with the one or more transceivers and the one or more memories. The one or more processors are configured to receive a guard interval integrated sensing and communications (GI-ISAC) configuration at the wireless device from a configuring node of a wireless network, where the GI-ISAC configuration is indicative of a set of one or more parameters describing characteristics of a GI-ISAC waveform to be used by the wireless device for RF sensing, where the set of one or more parameters describing characteristics of the GI-ISAC waveform is based at least in part on orthogonal frequency division multiplexing (OFDM) communication data symbols used by the wireless network. The one or more processors are also configured to perform an RF sensing function using the one or more transceivers in accordance with the GI-ISAC configuration.

An example configuring node, according to this description, may include one or more transceivers, one or more memories, and one or more processors communicatively coupled with the one or more transceivers and the one or more memories. The one or more processors are configured to determine a guard interval integrated sensing and communications (GI-ISAC) configuration, where the GI-ISAC configuration is indicative of a set of one or more parameters describing characteristics of a GI-ISAC waveform to be used by a wireless device to perform an radio frequency (RF) sensing function, where the set of one or more parameters describing characteristics of the GI-ISAC waveform is based at least in part on orthogonal frequency division multiplexing (OFDM) communication data symbols used by the wireless network. The one or more processors are further configured to send the GI-ISAC configuration to the wireless device via the one or more transceivers.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is an illustration of a positioning/sensing system that can use the techniques provided herein for utilizing a guard interval integrated sensing and communications (GI-ISAC) waveform for (RF) sensing, according to an embodiment.

FIG. 2 is a diagram of a fifth-generation (5G) new radio (NR) positioning/sensing system, according to an embodiment.

FIG. 3 is a diagram showing an example of an RF sensing system, according to an embodiment.

FIG. 4 is an illustration of diagrams representing different ways for implementing integrated sensing and communications (ISAC), according to some embodiments.

FIG. 5 is a diagram of an example of resource usage for different beams.

FIG. 6 is an illustration with diagrams offering a comparison between traditional cyclic prefix (CP)-based symbols and guard interval (GI)-based symbols, according to an example.

FIG. 7 is a call flow diagram of a process by which, according to some embodiments, a client node can request and receive GI-ISAC measurement information.

FIG. 8 is a flow diagram illustrating an example process of performing integrated radio frequency (RF) sensing and communications, according to some embodiments.

FIG. 9 is a flow diagram illustrating an example process of supporting integrated radio frequency (RF) sensing and communications, according to some embodiments.

FIG. 10 is a block diagram of an embodiment of a mobile sensing node.

FIG. 11 is a block diagram of an embodiment of a stationary sensing node.

FIG. 12 is a block diagram of an embodiment of a computer system.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3, etc., or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c). Drawings may be simplified for discussion purposes and may not reflect certain features of embodiments (e.g., sizes/dimensions, components, etc.) used in real-world applications.

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

As used herein, the terms “RF sensing,” “passive RF sensing,” and variants refer to a process by which one or more objects (which also may be referred to as “targets”) are detected using RF signals transmitted by a transmitting device and, after reflecting from the object(s), received by a receiving device. In a monostatic configuration, the transmitting and receiving devices are the same device. In a bistatic configuration, one device transmits RF signals, and another device receives reflections of the RF signals from one or more objects. In multi-static configuration, one or more receiving devices are separate from one or more transmitting devices. As used herein, the term “static” in the terms “monostatic,” “bistatic,” and “multistatic” (or “multi-static”) are meant to conform with historical literature on RF sensing but are not limited to “static” or stationary sensing nodes. As described herein, in some embodiments, sensing nodes may be mobile. As described herein, devices performing RF sensing may be referred to as “RF sensing nodes” or simply “sensing nodes.” In a bistatic or multi-static configuration, transmitting devices may be referred to as “transmitting nodes,” “Tx sensing nodes,” or “Tx nodes,” and receiving devices may be referred to as “receiving nodes,” “Rx sensing nodes,” or “Rx nodes.” A sensing node may be referred to as either or both in a monostatic configuration. As described hereafter in more detail, a receiving device can make measurements of these reflected RF signals to determine one or more characteristics of one or more objects, such as location, range, angle, direction, orientation, Doppler, velocity, etc. According to some embodiments, RF sensing may be “passive” in that no RF signals need to be transmitted by the receiving device or one or more objects for the one or more objects to be detected.

Additionally, unless otherwise specified, references to “reference signals” and the like may be used to refer to signals used for positioning of a user equipment (UE), sensing of active and/or passive objects by one or more sensing nodes, or a combination thereof. As described in more detail herein, such signals may comprise any of a variety of signal types. This may include but is not limited to, a positioning reference signal (PRS), sounding reference signal (SRS), synchronization signal block (SSB), channel start information reference signal (CSI-RS), or any combination thereof.

Techniques provided herein may apply to “mmWave” technologies, which typically operate at 57-71 GHz, but may include frequencies ranging from 30-300 GHz. This includes, for example, frequencies utilized by the 802.11ad Wi-Fi standard (operating at 60 GHz). That said, some embodiments may utilize RF sensing with frequencies outside this range. For example, in some embodiments, 5G NR frequency bands (e.g., 28 GHz) may be used. Because RF sensing may be performed in the same bands as communication, hardware may be utilized for both communication and RF sensing. For example, one or more of the components of an RF sensing system as described herein may be included in a wireless modem (e.g., Wi-Fi or NR modem), a UE (e.g., an extended device), or the like. Additionally, techniques may apply to RF signals comprising any of a variety of pulse types, including compressed pulses (e.g., comprising Chirp, Golay, Barker, Ipatov, or m sequences) may be utilized. That said, embodiments are not limited to such frequencies and/or pulse types. Additionally, because the RF sensing system may be capable of sending RF signals for communication (e.g., using 802.11 or NR wireless technology), embodiments may leverage channel estimation and/or other communication-related functions for providing RF sensing functionality as described herein. Accordingly, the pulses may be the same as those used in at least some aspects.

As noted, RF sensing may be performed by wireless devices, or sensing nodes, and can have a wide range of consumer, industrial, commercial, and other applications. RF sensing may utilize one or more sensing nodes and may be coordinated by a wireless network to detect and/or track or target objects. The ability to perform both RF sensing and communication, referred to as integrated sensing and communications (ISAC) or joint sensing and communications (JSC), is something that standards organizations such as 3rd Generation Partnership Project (3GPP) hope to support in future generations of cellular networks (e.g., 5G Advanced, 6G, and beyond). This can help support applications in a wide variety of areas such as vehicle sensing and automation, unmanned aerial vehicles (UAV), railway, gesture recognition, and more. The use of a single ISAC waveform for both RF sensing and communication may be advantageous for various reasons, including efficiency gains inherent in hardware and spectrum reuses. However, a traditional orthogonal frequency-division multiplexing (OFDM) communication scheme using a cyclic prefix (CP) (CP-OFDM) has many shortcomings with respect to supporting RF sensing (described in more detail hereafter).

Embodiments described herein address these and other issues by proposing a guard interval (GI)-based ISAC waveform capable of supporting RF sensing and communication (including traditional CP-OFDM for communication). Various aspects relate generally to the field of RF sensing and communication. Some aspects more specifically relate to using a guard interval integrated sensing and communications (GI-ISAC) at a sensing node (e.g., a UE), based on a GI-ISAC configuration, which may be received by a configuring node of a wireless network (e.g., a base station or server). The GI-ISAC configuration may include one or more parameters describing characteristics of the GI-ISAC waveform, where the one or more parameters may be based at least in part on OFDM communication data symbols used by the wireless network.

Particular aspects of the subject matter described in this disclosure can be implemented to realize one or more of the following potential advantages. In some examples, by utilizing a common waveform for RF sensing and communication, embodiments may enable efficiency gain through hardware and spectrum reuses, as noted above. Further, by basing the GI-ISAC waveform on OFDM communication data symbols, embodiments can help ensure that the GI-ISAC waveform is backward-compatible and does not interfere with traditional CP-OFDM communication. These and other advantages will be apparent to persons of ordinary skill in light of the disclosed embodiments detailed hereafter. A discussion of embodiments is provided after a discussion of relevant technology and context/background in which embodiments may be used.

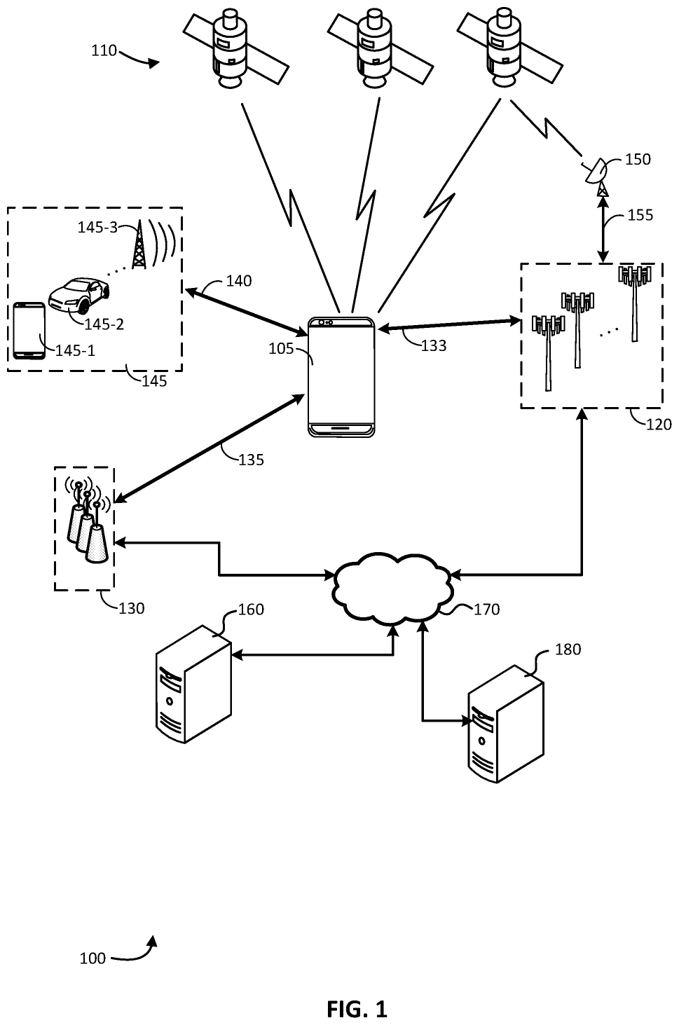

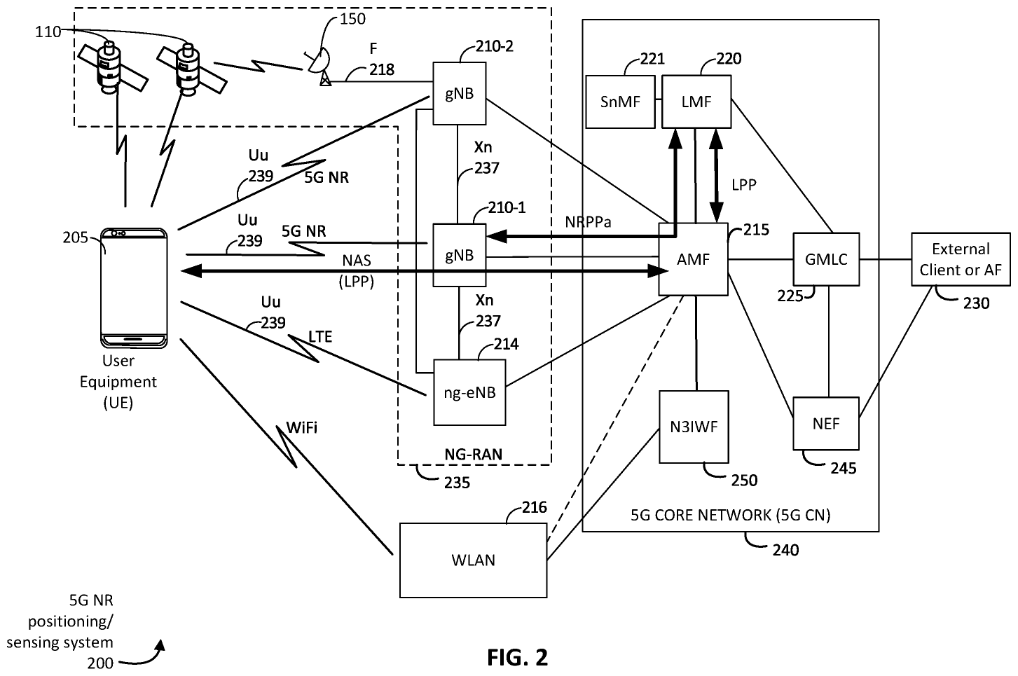

FIG. 1 is a simplified illustration of a positioning/sensing system 100, which may be implemented in conjunction with and/or as part of a wireless communication system (e.g., a cellular communication network) which a mobile device 105, location/sensing server 160, and/or other components of the positioning/sensing system 100 can use the techniques provided herein for using a GI-ISAC waveform, according to an embodiment. The techniques described herein may be implemented by one or more components of the positioning/sensing system 100, however, the techniques described herein are not limited to such components and may be implemented in other types of systems (not shown). The positioning/sensing system 100 can include a mobile device 105; one or more satellites 110 (also referred to as space vehicles (SVs)) for a Global Navigation Satellite System (GNSS) (such as the Global Positioning System (GPS), GLONASS, Galileo or Beidou) and/or NTN functionality; base stations 120; access points (APs) 130; location/sensing server 160; network 170; and external client 180. Generally put, the positioning/sensing system 100 can estimate the location of the mobile device 105 based on RF signals received by and/or sent from the mobile device 105 and known locations of other components (e.g., GNSS satellites 110, base stations 120, APs 130) transmitting and/or receiving the RF signals. Additionally or alternatively, wireless devices such as the mobile device 105, base stations 120, and satellites 110 (and/or other NTN platforms, which may be implemented on airplanes, drones, balloons, etc.) can be utilized to perform positioning (e.g., of one or more wireless devices) and/or perform RF sensing (e.g., of one or more objects by using RF signals transmitted by one or more wireless devices). Additional details regarding particular location estimation/sensing techniques are discussed with regard to FIG. 2.

It should be noted that FIG. 1 provides only a generalized illustration of various components, any or all of which may be utilized as appropriate, and each of which may be duplicated, as necessary. Specifically, although only one mobile device 105 is illustrated, it will be understood that many UEs (e.g., hundreds, thousands, millions, etc.) may utilize the positioning/sensing system 100. Similarly, the positioning/sensing system 100 may include a larger or smaller number of base stations 120 and/or APs 130 than illustrated in FIG. 1. The illustrated connections that connect the various components in the positioning/sensing system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location/sensing server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G, and NR are wireless technologies defined, or being defined, by the 3rd Generation Partnership Project (3GPP). In an LTE, 5G, or other cellular network, mobile device 105 may be referred to as a user equipment (UE). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, mobile device 105 can send and receive information with network-connected devices, such as location/sensing server 160, by accessing the network 170 via a base station 120 using a first communication link 133. Additionally or alternatively, because APs 130 also may be communicatively coupled with the network 170, mobile device 105 may communicate with network-connected and Internet-connected devices, including location/sensing server 160, using a second communication link 135, or via one or more other mobile devices 145. As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). According to aspects of applicable 5G cellular standards, a base station 120 (e.g., gNB) may be capable of transmitting different “beams” in different directions and performing “beam sweeping” in which a signal is transmitted in different beams, along different directions (e.g., one after the other). The term “base station” used herein may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As noted, satellites 110 may be used to implement NTN functionality, extending communication, positioning, and potentially other functionality (e.g., RF sensing) of a terrestrial network. As such, one or more satellites may be communicatively linked to one or more NTN gateways 150 (also known as “gateways,” “earth stations,” or “ground stations”). The NTN gateways 150 may be communicatively linked with base stations 120 via link 155. In some embodiments, NTN gateways 150 may function as DUs of a base station 120, as described previously. Not only can this enable the mobile device 105 to communicate with the network 170 via satellites 110, but this can also enable network-based positioning, RF sensing, etc.

Satellites 110 may be utilized in one or more way. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the mobile device 105 to perform code-based and/or carrier-based positioning, which can be highly accurate. Additionally or alternatively, satellites 110 may be utilized for NTN-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120 and may be coordinated by a network function server 160, which may operate as a location server. In some embodiments, satellites 110 used for NTN-based positioning may be different than those used for GNSS-based positioning. In some embodiments NTN nodes may include non-terrestrial vehicles such as airplanes, balloons, drones, etc., which may be in addition or as an alternative to NTN satellites. NTN satellites 110 and/or other NTN platforms may be further leveraged to perform RF sensing. As described in more detail hereafter, satellites may use a JCS symbol in an Orthogonal Frequency-Division Multiplexing (OFDM) waveform to allow both RF sensing and/or positioning, and communication.

As used herein, the term “cell” may generically refer to a logical communication entity used for communication with a base station 120 and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

The location/sensing server 160 may comprise a server and/or other computing device configured to determine an estimated location of mobile device 105 and/or provide data (e.g., “assistance data”) to mobile device 105 to facilitate location measurement and/or location determination by mobile device 105. According to some embodiments, location/sensing server 160 may comprise a Home Secure User Plane Location (SUPL) Location Platform (H-SLP), which may support the SUPL user plane (UP) location solution defined by the Open Mobile Alliance (OMA) and may support location services for mobile device 105 based on subscription information for mobile device 105 stored in location/sensing server 160. In some embodiments, the location/sensing server 160 may comprise, a Discovered SLP (D-SLP) or an Emergency SLP (E-SLP). The location/sensing server 160 may also comprise an Enhanced Serving Mobile Location Center (E-SMLC) that supports location of mobile device 105 using a control plane (CP) location solution for LTE radio access by mobile device 105. The location/sensing server 160 may further comprise a Location Management Function (LMF) that supports location of mobile device 105 using a control plane (CP) location solution for NR or LTE radio access by mobile device 105.

In a CP location solution, signaling to control and manage the location of mobile device 105 may be exchanged between elements of network 170 and with mobile device 105 using existing network interfaces and protocols and as signaling from the perspective of network 170. In a UP location solution, signaling to control and manage the location of mobile device 105 may be exchanged between location/sensing server 160 and mobile device 105 as data (e.g. data transported using the Internet Protocol (IP) and/or Transmission Control Protocol (TCP)) from the perspective of network 170.

As previously noted (and discussed in more detail below), the estimated location of mobile device 105 may be based on measurements of RF signals sent from and/or received by the mobile device 105. In particular, these measurements can provide information regarding the relative distance and/or angle of the mobile device 105 from one or more components in the positioning/sensing system 100 (e.g., satellites 110, APs 130, base stations 120). The estimated location of the mobile device 105 can be estimated geometrically (e.g., using multiangulation and/or multilateration), based on the distance (range) and/or angle measurements, along with known position of the one or more components.

Additionally or alternatively, the location/sensing server 160, may function as a sensing server. A sensing server can be used to coordinate and/or assist in the coordination of sensing of one or more objects (also referred to herein as “targets”) by one or more wireless devices in the positioning/sensing system 100. This can include the mobile device 105, base stations 120, APs 130, other mobile devices 145, satellites 110, or any combination thereof. Wireless devices capable of performing RF sensing may be referred to herein as “sensing nodes.” To perform RF sensing, a sensing server may coordinate sensing sessions in which one or more RF sensing nodes may perform RF sensing by transmitting RF signals (e.g., reference signals (RSs)), and measuring reflected signals, or “echoes,” comprising reflections of the transmitted RF signals off of one or more objects/targets. Reflected signals and object/target detection may be determined, for example, from channel state information (CSI) received at a receiving device. Sensing may comprise (i) monostatic sensing using a single device as a transmitter (of RF signals) and receiver (of reflected signals); (ii) bistatic sensing using a first device as a transmitter and a second device as a receiver; or (iii) multi-static sensing using a plurality of transmitters and/or a plurality of receivers. To facilitate sensing (e.g., in a sensing session among one or more sensing nodes), a sensing server may provide data (e.g., “assistance data”) to the sensing nodes to facilitate RS transmission and/or measurement, object/target detection, or any combination thereof. Such data may include an RS configuration indicating which resources (e.g., time and/or frequency resources) may be used (e.g., in a sensing session) to transmit RS for RF sensing. According to some embodiments, a sensing server may comprise a Sensing Management Function (SMF or SnMF).

Although terrestrial components such as APs 130 and base stations 120 may be fixed, embodiments are not so limited. Mobile components may be used. For example, in some embodiments, a location of the mobile device 105 may be estimated at least in part based on measurements of RF signals 140 communicated between the mobile device 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the mobile device 105, or a combination thereof. Wireless signals from mobile devices 145 used for positioning of the mobile device 105 may comprise RF signals using, for example, Bluetooth® (including Bluetooth Low Energy (BLE)), IEEE 802.11x (e.g., Wi-Fi®), Ultra-Wideband (UWB), IEEE 802.15x, or a combination thereof. Mobile devices 145 may additionally or alternatively use non-RF wireless signals for positioning of the mobile device 105, such as infrared signals or other optical technologies.

Mobile devices 145 may comprise other UEs communicatively coupled with a cellular or other mobile network (e.g., network 170). When one or more other mobile devices 145 comprising UEs are used in the position determination of a particular mobile device 105, the mobile device 105 for which the position is to be determined may be referred to as the “target UE,” and each of the other mobile devices 145 used may be referred to as an “anchor UE.” For position determination of a target UE, the respective positions of the one or more anchor UEs may be known and/or jointly determined with the target UE. Direct communication between the one or more other mobile devices 145 and mobile device 105 may comprise sidelink and/or similar Device-to-Device (D2D) communication technologies. Sidelink, which is defined by 3GPP, is a form of D2D communication under the cellular-based LTE and NR standards.

According to some embodiments, such as when the mobile device 105 comprises and/or is incorporated into a vehicle, a form of D2D communication used by the mobile device 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The mobile device 105 illustrated in FIG. 1 may correspond to a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the mobile device 105 and may be used to determine the position of the mobile device 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the mobile device 105, according to some embodiments.

An estimated location of mobile device 105 can be used in a variety of applications—e.g. to assist direction finding or navigation for a user of mobile device 105 or to assist another user (e.g. associated with external client 180) to locate mobile device 105. A “location” is also referred to herein as a “location estimate,” “estimated location,” “location,” “position,” “position estimate,” “position fix,” “estimated position,” “location fix” or “fix.” The process of determining a location may be referred to as “positioning,” “position determination,” “location determination,” or the like. A location of mobile device 105 may comprise an absolute location of mobile device 105 (e.g. a latitude and longitude and possibly altitude) or a relative location of mobile device 105 (e.g. a location expressed as distances north or south, east or west and possibly above or below some other known fixed location (including, e.g., the location of a base station 120 or AP 130) or some other location such as a location for mobile device 105 at some known previous time, or a location of a mobile device 145 (e.g., another UE) at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which mobile device 105 is expected to be located with some level of confidence (e.g. 95% confidence).

The external client 180 may be a web server or remote application that may have some association with mobile device 105 (e.g. may be accessed by a user of mobile device 105) or may be a server, application, or computer system providing a location service to some other user or users which may include obtaining and providing the location of mobile device 105 (e.g. to enable a service such as friend or relative finder, or child or pet location). Additionally or alternatively, the external client 180 may obtain and provide the location of mobile device 105 to an emergency services provider, government agency, etc.

As previously noted, the example positioning/sensing system 100 can be implemented using a wireless communication network, such as an LTE-based or 5G NR-based network, or a future 6G network. FIG. 2 shows a diagram of a 5G NR positioning/sensing system 200, illustrating an embodiment of a positioning/sensing system (e.g., positioning/sensing system 100) implemented in 5G NR. The 5G NR positioning/sensing system 200 may be configured to enable wireless communication, determine the location of a UE 205 (which may correspond to the mobile device 105 of FIG. 1), perform RF sensing, or a combination thereof, by using access nodes, which may include NR NodeB (gNB) 210-1 and 210-2 (collectively and generically referred to herein as gNBs 210), ng-eNB 214, and/or WLAN 216 to implement one or more positioning methods. These access nodes can use RF signaling to enable the communication, implement one or more positioning methods, and/or implement RF sensing. The gNBs 210 and/or the ng-eNB 214 may correspond with base stations 120 of FIG. 1, and the WLAN 216 may correspond with one or more access points 130 of FIG. 1. Optionally, the 5G NR positioning/sensing system 200 additionally may be configured to determine the location of a UE 205 by using an LMF 220 (which may correspond with location/sensing server 160) to implement the one or more positioning methods. The SnMF 221 may coordinate RF sensing by the 5G NR positioning/sensing system 200. Here, the 5G NR positioning/sensing system 200 comprises a UE 205, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network. Additional components of the 5G NR positioning/sensing system 200 are described below. The 5G NR positioning/sensing system 200 may include additional or alternative components.

The 5G NR positioning/sensing system 200 may further utilize information from satellites 110. As previously indicated, satellites 110 may comprise GNSS satellites from a GNSS system like Global Positioning/sensing system (GPS) or similar system (e.g. GLONASS, Galileo, Beidou, Indian Regional Navigational Satellite System (IRNSS)). Additionally or alternatively, satellites 110 may comprise NTN satellites. NTN satellites may be in low earth orbit (LEO), medium earth orbit (MEO), geostationary earth orbit (GEO) or some other type of orbit. NTN satellites may be communicatively coupled with the LMF 220 and may operatively function as a TRP (or TP) in the NG-RAN 235. As such, satellites 110 may be in communication with one or more gNBs 210 via one or more NTN gateways 150. According to some embodiments, an NTN gateway 150 may operate as a DU of a gNB 210, in which case communications between NTN gateway 150 and CU of the gNB 210 may occur over an F interface 218 between DU and CU.

It should be noted that FIG. 2 provides only a generalized illustration of various components, any or all of which may be utilized as appropriate, and each of which may be duplicated or omitted, as necessary. Specifically, although only one UE 205 is illustrated, it will be understood that many UEs (e.g., hundreds, thousands, millions, etc.) may utilize the 5G NR positioning/sensing system 200. Similarly, the 5G NR positioning/sensing system 200 may include a larger (or smaller) number of satellites 110, gNBs 210, ng-eNBs 214, Wireless Local Area Networks (WLANs) 216, Access and mobility Management Functions (AMF)s 215, external clients 230, and/or other components. The illustrated connections that connect the various components in the 5G NR positioning/sensing system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 205 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 205 may correspond to a cellphone, smartphone, laptop, tablet, personal data assistant (PDA), navigation device, Internet of Things (IoT) device, or some other portable or moveable device. Typically, though not necessarily, the UE 205 may support wireless communication using one or more Radio Access Technologies (RATs) such as using GSM, CDMA, W-CDMA, LTE, High-Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 205 may also support wireless communication using a WLAN 216 which (like the one or more RATs, and as previously noted with respect to FIG. 1) may connect to other networks, such as the Internet. The use of one or more of these RATs may allow the UE 205 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 205 (e.g., via the GMLC 225). The external client 230 of FIG. 2 may correspond to external client 180 of FIG. 1, as implemented in or communicatively coupled with a 5G NR network.

The UE 205 may include a single entity or may include multiple entities, such as in a personal area network where a user may employ audio, video and/or data I/O devices, and/or body sensors and a separate wireline or wireless modem. An estimate of a location of the UE 205 may be referred to as a location, location estimate, location fix, fix, position, position estimate, or position fix, and may be geodetic, thus providing location coordinates for the UE 205 (e.g., latitude and longitude), which may or may not include an altitude component (e.g., height above sea level, height above or depth below ground level, floor level or basement level). Alternatively, a location of the UE 205 may be expressed as a civic location (e.g., as a postal address or the designation of some point or small area in a building such as a particular room or floor). A location of the UE 205 may also be expressed as an area or volume (defined either geodetically or in civic form) within which the UE 205 is expected to be located with some probability or confidence level (e.g., 67%, 95%, etc.). A location of the UE 205 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 205 via wireless communication between the UE 205 and one or more of the gNBs 210, which may provide wireless communications access to the 5G CN 240 on behalf of the UE 205 using 5G NR. The wireless interface between base stations (gNBs 210 and/or ng-eNB 214) and the UE 205 may be referred to as a Uu interface 239. 5G NR radio access may also be referred to as NR radio access or as 5G radio access. In FIG. 2, the serving gNB for UE 205 is assumed to be gNB 210-1, although other gNBs (e.g. gNB 210-2) may act as a serving gNB if UE 205 moves to another location or may act as a secondary gNB to provide additional throughput and bandwidth to UE 205.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (eLTE) wireless access to UE 205. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 205 but may not receive signals from UE 205 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 205. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR positioning/sensing system 200, such as the LMF 220 and AMF 215.

5G NR positioning/sensing system 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 205 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 205 to other elements in 5G CN 240 and/or may support interworking of one or more protocols used by WLAN 216 and UE 205 to one or more protocols used by other elements of 5G CN 240 such as AMF 215. For example, N3IWF 250 may support IPSec tunnel establishment with UE 205, termination of IKEv2/IPSec protocols with UE 205, termination of N2 and N3 interfaces to 5G CN 240 for control plane and user plane, respectively, relaying of uplink (UL) and downlink (DL) control plane Non-Access Stratum (NAS) signaling between UE 205 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 205 and the AMF 215. As noted, this can include gNBs 210, ng-eNB 214, WLAN 216, and/or other types of cellular base stations, and may also include NTN satellites 110. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214, WLAN 216, or NTN satellite 110.

In some embodiments, an access node, such as a gNB 210, ng-eNB 214, WLAN 216, or NTN satellite 110, or a combination thereof, (alone or in combination with other components of the 5G NR positioning/sensing system 200), may be configured to, in response to receiving a request for location information from the LMF 220, obtain location measurements of uplink (UL) signals received from the UE 205) and/or obtain downlink (DL) location measurements from the UE 205 that were obtained by UE 205 for DL signals received by UE 205 from one or more access nodes. As noted, while FIG. 2 depicts access nodes (gNB 210, ng-eNB 214, WLAN 216, and NTN satellite 110) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 205, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 205 may be applicable to such other networks.

The gNBs 210 and ng-eNB 214 can communicate with an AMF 215, which, for positioning functionality, communicates with an LMF 220. The AMF 215 may support mobility of the UE 205, including cell change and handover of UE 205 from an access node (e.g., gNB 210, ng-eNB 214, WLAN 216, or NTN satellite 110) of a first RAT to an access node of a second RAT. The AMF 215 may also participate in supporting a signaling connection to the UE 205 and possibly data and voice bearers for the UE 205. The LMF 220 may support positioning of the UE 205 using a CP location solution when UE 205 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Frequency Difference Of Arrival (FDOA), Real Time Kinematic (RTK), Precise Point Positioning (PPP), Differential GNSS (DGNSS), Enhance Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 205, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 205's location) may be performed at the UE 205 (e.g., by measuring downlink PRS (DL-PRS) signals transmitted by wireless nodes such gNB 210, ng-eNB 214, WLAN 216, or NTN satellite 110, and/or using assistance data provided to the UE 205, e.g., by LMF 220).

The Gateway Mobile Location Center (GMLC) 225 may support a location request for the UE 205 received from an external client 230 and may forward such a location request to the AMF 215 for forwarding by the AMF 215 to the LMF 220. A location response from the LMF 220 (e.g., containing a location estimate for the UE 205) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 205 to the external client 230, which may then be referred to as an Access Function (AF) and may enable the secure provision of information from the external client 230 to 5GCN 240. NEF 245 may be connected to AMF 215 and/or to GMLC 225 for the purposes of obtaining a location (e.g. a civic location) of UE 205 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 205 may communicate using an LTE Positioning Protocol (LPP) as defined in 3GPP TS 37.355. Here, LPP messages may be transferred between the UE 205 and the LMF 220 via the AMF 215 and a serving gNB 210-1 or serving ng-eNB 214 for UE 205. For example, LPP messages may be transferred between the LMF 220 and the AMF 215 using messages for service-based operations (e.g., based on the Hypertext Transfer Protocol (HTTP)) and may be transferred between the AMF 215 and the UE 205 using a 5G NAS protocol. The LPP protocol may be used to support positioning of UE 205 using UE assisted and/or UE-based position methods such as A-GNSS, RTK, TDOA, multi-cell RTT, AoD, and/or ECID. The NRPPa protocol may be used to support positioning of UE 205 using network-based position methods such as ECID, AoA, uplink TDOA (UL-TDOA) and/or may be used by LMF 220 to obtain location-related information from gNBs 210 and/or ng-eNB 214, such as parameters defining DL-PRS transmission from gNBs 210 and/or ng-eNB 214.

In the case of UE 205 access to WLAN 216, LMF 220 may use NRPPa and/or LPP to obtain a location of UE 205 in a similar manner to that just described for UE 205 access to a gNB 210 or ng-eNB 214. Thus, NRPPa messages may be transferred between a WLAN 216 and the LMF 220, via the AMF 215 and N3IWF 250 to support network-based positioning of UE 205 and/or transfer of other location information from WLAN 216 to LMF 220. Alternatively, NRPPa messages may be transferred between N3IWF 250 and the LMF 220, via the AMF 215, to support network-based positioning of UE 205 based on location-related information and/or location measurements known to or accessible to N3IWF 250 and transferred from N3IWF 250 to LMF 220 using NRPPa. Similarly, LPP and/or LPP messages may be transferred between the UE 205 and the LMF 220 via the AMF 215, N3IWF 250, and serving WLAN 216 for UE 205 to support UE-assisted or UE-based positioning of UE 205 by LMF 220.

With a UE-based position method, UE 205 may obtain location measurements (e.g., which may be the same as or similar to location measurements for a UE-assisted position method) and may further compute a location of UE 205 (e.g., with the help of assistance data received from a location server such as LMF 220, an SLP, or broadcast by gNBs 210, ng-eNB 214, or WLAN 216).

With a network-based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AoA, or TOA) for signals transmitted by UE 205, and/or may receive measurements obtained by UE 205 or by an AP in WLAN 216 in the case of N3IWF 250, and may send the measurements to a location server (e.g., LMF 220) for computation of a location estimate for UE 205.

Positioning of the UE 205 also may be categorized as UL, DL, or DL-UL based, depending on the types of signals used for positioning. If, for example, positioning is based solely on signals received at the UE 205 (e.g., from a base station or other UE), the positioning may be categorized as DL based. On the other hand, if positioning is based solely on signals transmitted by the UE 205 (which may be received by a base station or other UE, for example), the positioning may be categorized as UL based. Positioning that is DL-UL based includes positioning, such as RTT-based positioning, which is based on signals that are both transmitted and received by the UE 205. Sidelink (SL)-assisted positioning comprises signals communicated between the UE 205 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AoD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AoD and/or AoA.

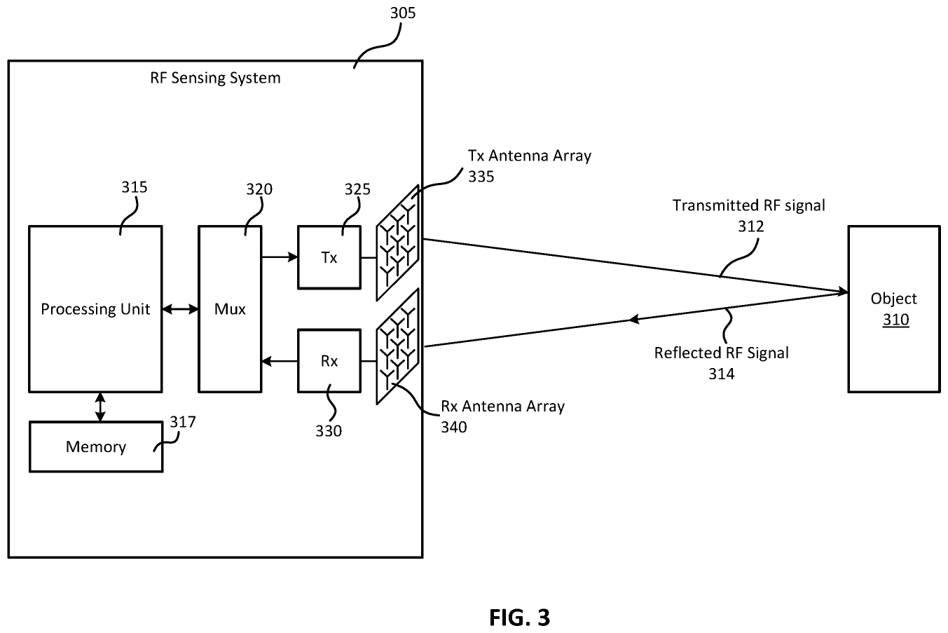

The principles described above with respect to positioning may be generally extended to RF sensing. That is, RF sensing may be UE-based (e.g., originated from the UE) and/or UE assisted (e.g., originated from a non-UE entity), and may involve UL signals, DL signals, or both. However, RF sensing may differ from positioning in various ways. For example, as previously noted and described in more detail below, RF sensing may involve the use of specific RF sensing signals and/or ISAC signals. Further, RF sensing may be performed in a monostatic, bistatic, or multi-static manner, as described above, where RF sensing nodes comprise a UE (e.g., UE 205) and/or one or more access nodes (e.g., gNBs 210, ng-eNB 214, WLAN 216, NTN satellites 110, or any combination thereof). Various aspects of RF sensing are described below in more detail with respect to FIG. 3.

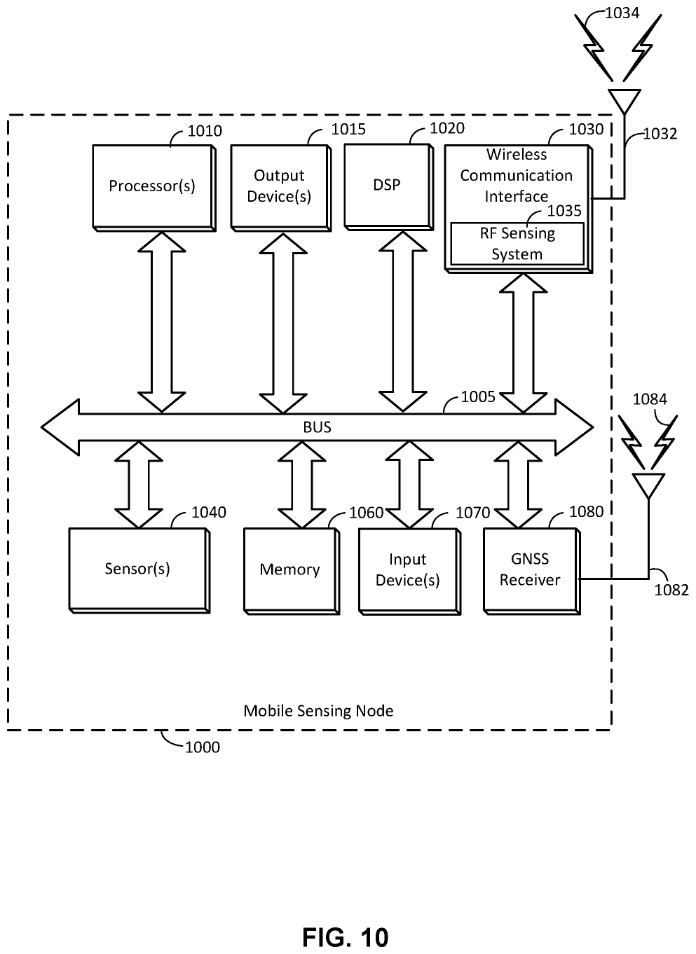

FIG. 3 is a diagram showing an example of an RF sensing system 305 and associated terminology. As used herein, the terms “waveform” and “sequence” and derivatives thereof are used interchangeably to refer to RF signals generated by a transmitter of the RF sensing system and received by a receiver of the RF sensing system for object detection. A “pulse” and derivatives thereof are generally referred to herein as waveforms comprising a sequence or complementary pair of sequences transmitted and received to generate a channel impulse response (CIR). The RF sensing system 305 may comprise a standalone device or may be integrated into a larger electronic device (e.g., the UE disclosed herein), such as a mobile phone, a base station/access node, a satellite, or another type of sensing node as described herein. (Example components of such electronic devices are illustrated in FIGS. 10-12, discussed in detail hereafter.) It can be noted that although the example RF sensing system 305 of FIG. 3 is illustrated in a monostatic configuration, embodiments are not so limited. As noted elsewhere herein, RF sensing nodes may be configured to perform RF sensing in a monostatic, bistatic, or multi-static configuration, or any combination thereof (e.g., depending on the circumstances of a particular instance). As such, components of an RF sensing system 305 within an RF sensing node may vary. For example, RF sensing nodes performing only transmitting or only receiving during RF sensing may include only respective components related to the transmitting or receiving. Again, embodiments may vary, depending on desired functionality.

With regard to the functionality of the RF sensing system 305 in FIG. 3, the RF sensing system 305 can detect the distance, direction, and/or speed of objects of an object 310 by generating a series of transmitted RF signals 312 (comprising one or more pulses). Some of these transmitted RF signals 312 reflect off of the object 310, and these reflected RF signals 314 (or “echoes”) are then processed by the RF sensing system 305 using beamforming (BF) and digital signal processing (DSP) techniques to determine the object's location (azimuth, elevation, velocity (e.g., from Doppler measurements), and range) relative to the RF sensing system 305. CFAR may be part of this processing, but may not necessarily be used in every instance, or “occasion,” in which RF sensing is performed.

To enable RF sensing, RF sensing system 305 may include a processing unit 315, memory 317, multiplexer (mux) 320, Tx processing circuitry 325, and Rx processing circuitry 330. (The RF sensing system 305 may include additional components not illustrated, such as a power source, user interface, or electronic interface). It can be noted, however, that these components of the RF sensing system 305 may be rearranged or otherwise altered in alternative embodiments, depending on desired functionality. Moreover, as used herein, the terms “transmit circuitry” or “Tx circuitry” refer to any circuitry utilized to create and/or transmit the transmitted RF signal 312. Likewise, the terms “receive circuitry” or “Rx circuitry” refer to any circuitry utilized to detect and/or process the reflected RF signal 314. As such, “transmit circuitry” and “receive circuitry” may not only comprise the Tx processing circuitry 325 and Rx processing circuitry 330 respectively but may also comprise the mux 320 and processing unit 315. In some embodiments, the processing unit may compose at least part of a modem and/or wireless communications interface. In some embodiments, more than one processing unit may be used to perform the functions of the processing unit 315 described herein.

The Tx processing circuitry 325 and Rx circuitry 330 may comprise subcomponents for respectively generating and detecting RF signals. As a person of ordinary skill in the art will appreciate, the Tx processing circuitry 325 may therefore include a pulse generator, digital-to-analog converter (DAC), a mixer (for up-mixing the signal to the transmit frequency), one or more amplifiers (for powering the transmission via Tx antenna array 335), etc. The Rx processing circuitry 330 may have similar hardware for processing a detected RF signal. In particular, the Rx processing circuitry 330 may comprise an amplifier (for amplifying a signal received via Rx antenna 340), a mixer for down-converting the received signal from the transmit frequency, an analog-to-digital converter (ADC) for digitizing the received signal, and a pulse correlator providing a matched filter for the pulse generated by the Tx processing circuitry 325. The Rx processing circuitry 330 may therefore use the correlator output as the CIR, which can be processed by the processing unit 315 (or other circuitries). Processing of the CIR may include object detecting, range, speed, or direction of arrival (DoA) estimation.

Beamforming is further enabled by a Tx antenna array 335 and an Rx antenna array 340. Each antenna array 335, 340 comprises a plurality of antenna elements. It can be noted that, although the antenna arrays 335, 340 of FIG. 3 include two-dimensional arrays, embodiments are not so limited. Arrays may simply include a plurality of antenna elements along a single dimension that provides for spatial cancellation between the Tx and Rx sides of the RF sensing system 305. As a person of ordinary skill in the art will appreciate, the relative location of the Tx and Rx sides, in addition to various environmental factors can impact how spatial cancellation may be performed.

It can be noted that the properties of the transmitted RF signal 312 may vary, depending on the technologies utilized. Techniques provided herein can apply generally to “mmWave” technologies, which typically operate at 57-71 GHz, but may include frequencies ranging from 30-300 GHz. This includes, for example, frequencies utilized by the 802.11ad Wi-Fi standard (operating at 60 GHz). That said, some embodiments may utilize RF signals with frequencies outside this range. For example, in some embodiments, 5G frequency bands (e.g., 28 GHz) may be used.

Because RF sensing may be performed in the same frequency bands as communication (e.g., cellular and/or WLAN communication), hardware may be utilized for both communication and RF sensing, as previously noted. For example, one or more of the components of the RF sensing system 305 shown in FIG. 3 may be included in a wireless modem (e.g., Wi-Fi, 5G, or other modems). Additionally, techniques may apply to RF signals comprising any of a variety of pulse types, including compressed pulses (e.g., comprising Chirp, Golay, Barker, Ipatov, or m sequences) may be utilized. That said, embodiments are not limited to such frequencies and/or pulse types. Additionally, because the RF sensing system may be capable of sending RF signals for communication (e.g., using 802.11 communication technology), embodiments may leverage channel estimation used in communication for performing the RF sensing as provided herein. Accordingly, the pulses may be the same as those used for channel estimation in communication.

As noted, the RF sensing system 305 may be integrated into an electronic device in which RF sensing is desired (e.g., mobile device 105 and/or UE 205). For example, the RF sensing system 305, which can perform RF sensing, may be part of the communication hardware found in modern mobile phones. Other devices, too, may utilize the techniques provided herein. These can include, for example, other mobile devices (e.g., tablets, portable media players, laptops, wearable devices, other electronic devices (e.g., security devices, on-vehicle systems, specialized or dedicated RF sensing devices), wireless nodes of the communication network (e.g., access nodes, such as base stations and/or satellites), or the like. That said, electronic devices (e.g., RF sensing nodes) into which an RF sensing system 305 may be integrated are not limited to such devices.

In RF sensing, a wireless signal can be transmitted from one or multiple transmit points and received at one or multiple receive points after being reflected off a target. RF sensing can enable many candidate applications, including intruder detection, animal/pedestrian/unmanned aerial vehicle (UAV) intrusion detection in highways and railways, rainfall monitoring, flooding awareness, autonomous driving, automated guided vehicle (AGV) detection/tracking/collision avoidance, smart parking and assistance, UAV trajectory and tracking, crowd management, sleep/health monitoring, gesture recognition, extended reality (XR) streaming, public safety, search and rescue, and more. Further, RF sensing is expected to be incorporated into wireless standards (e.g., 5G), and therefore may be performed in the future in a cellular network.

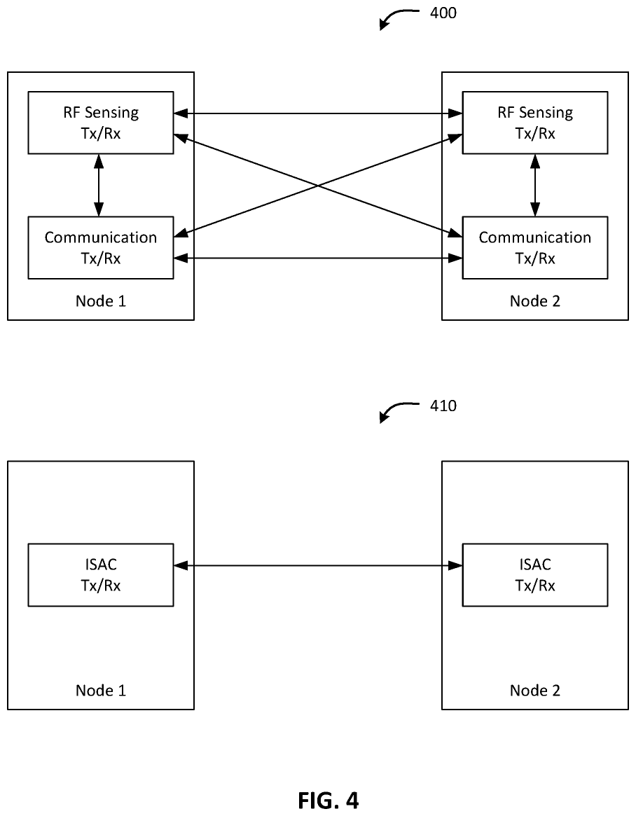

As previously noted, future generations of cellular networks (e.g., 5G Advanced, 6G, etc.) are planned to support ISAC to enable UE to perform both RF sensing and communication. The implementation of ISAC may be done in two ways, as illustrated in FIG. 4.

FIG. 4 is an illustration of diagrams representing different ways of implementing ISAC, according to some embodiments. The first diagram 400 represents an implementation having co-located and cooperative radar and communication systems. Here, Node 1 and Node 2 represent ISAC implementations of wireless nodes in a wireless network. In a cellular network, such as a 5G network, Node 1 and Node 2 may represent a UE, base station, or other wireless device, for example. As illustrated, Nodes can perform RF sensing using RF sensing components (e.g., RF sensing system 305 of FIG. 3), and may further communicate using communication components. As further illustrated, RF sensing and communication components may be separate, but may be in communication with each other. The use of separate components in this manner may therefore require coordination between components, additional circuitry, etc.

The second diagram 410 represents a second implementation having a co-design of communication and RF sensing systems. That is, in this implementation, a common set of one or more transmitters, receivers, and/or transmitters may be used for both communication and RF sensing functionalities. This implementation may require a significant modification in the transmit waveform generation or the receiver processing of either or both RF sensing and/or communication circuitry. That said, the use of a co-design implementation in this matter has the advantages described above, such as efficiency gains in hardware and spectrum reuse.

However, the use of the traditional waveform for communication, CP-OFDM, may not be a suitable solution for ISAC implementations. CP-OFDM suffers from signal energy loss and inter-symbol interference (ISI) and inter-carrier interference (ICI) effects for sensing detection/estimation when a delay spread is larger than the CP length or when velocity is larger than subcarrier spacing (STS). For example, RF sensing requirements for automotive applications may need 300 m of sensing range, good velocity resolution, and a large maximum velocity detection. However, a CP duration that is relatively short may not accommodate these requirements. Further, a dedicated reference signal for RF sensing may take a large overhead for velocity estimation due to the large time integration needed to achieve high-velocity resolution requirements. The integration of CP-OFDM data with such a reference signal may further entail a large amount of hardware complexity and large memory due to the needs of such integration.

For example, CP-OFDM used for single-stage sensing suffers from considerable overhead and latency issues that may be incompatible with the requirements of various applications, such as automotive applications. For instance, single-stage symbol-based sensing may take place over a 5 ms duration (corresponding to 40 slots at a subcarrier spacing (SCS) of 120 kHz) to offer continuous sensing with a wide bandwidth of 400 MHz for each beam. This consumes a large amount of system resources-up to 5% per beam and user for a 20 frames per second (fps) update rate. When accounting for a desired Field of View (FoV) (e.g., across nine beams) that may be needed for certain applications (e.g., automotive), as much as 45% of the system resources may be utilized within 45 ms. Such expenditure of resources places a significant burden on communication capabilities, inducing high latency that affects the timely transmission of communication data and potentially disrupting communication assistance functionalities like beam management and synchronization.

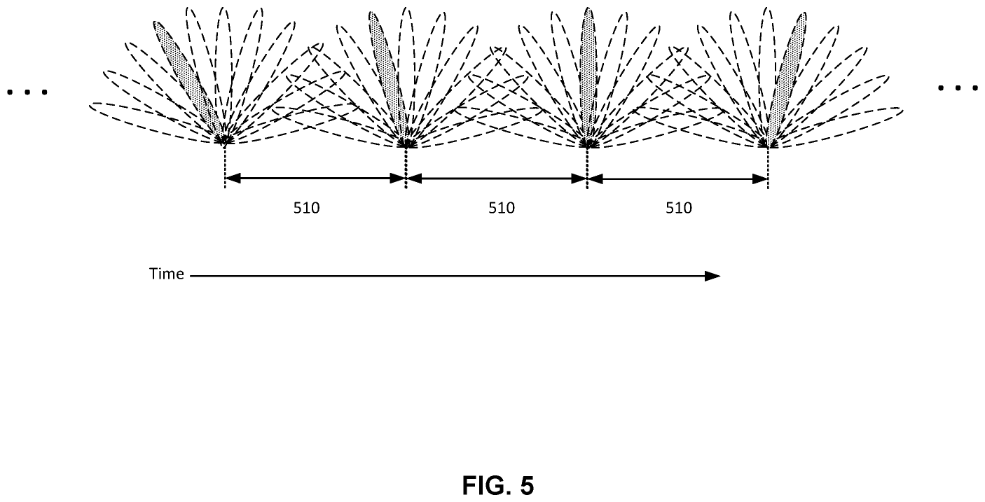

FIG. 5 is a diagram of an example that helps illustrate resource usage for different beams. Here, different beams (darkened) are used for RF sensing at different times. A coherent processing interval (CPI) 510 may define the time span over which RF signals are processed (e.g., for creating a single frame of data). The configuration (e.g., the number of symbols included and/or the duration) of the CPI 510 may affect the determination of the velocity and range resolution of detected objects. For example, a single CPI might consist of numerous slots/symbols at a specific subcarrier spacing, which indicates how finely the RF sensing can discern between different objects in terms of distance and relative speed. As noted above, in the context of single-stage sensing, the CPIs 510 may involve a continuous monitoring period with a wide bandwidth, consuming a significant portion of system resources for each beam, as shown in FIG. 5. This high consumption, especially when considered for multiple beams over a short period, can lead to a significant system burden.

Additionally, a CP is an extra overhead for RF sensing and communication and may have limited benefits. For example, CP may only enable circular convolution benefits if range speed is less than delay, and CP may also cause discontinuity. Further, a CP may not be “tuned” to the needs of particular RF sensing applications. For example, if range spread is much less than CP, it can result in poor throughput. On the other hand, if range spread is much larger than CP, it can result in signal energy loss and interference. Ultimately, the use of a CP in RF sensing may be limited to estimate velocities with poor resolution at a relatively high signal-to-noise ratio (SNR).

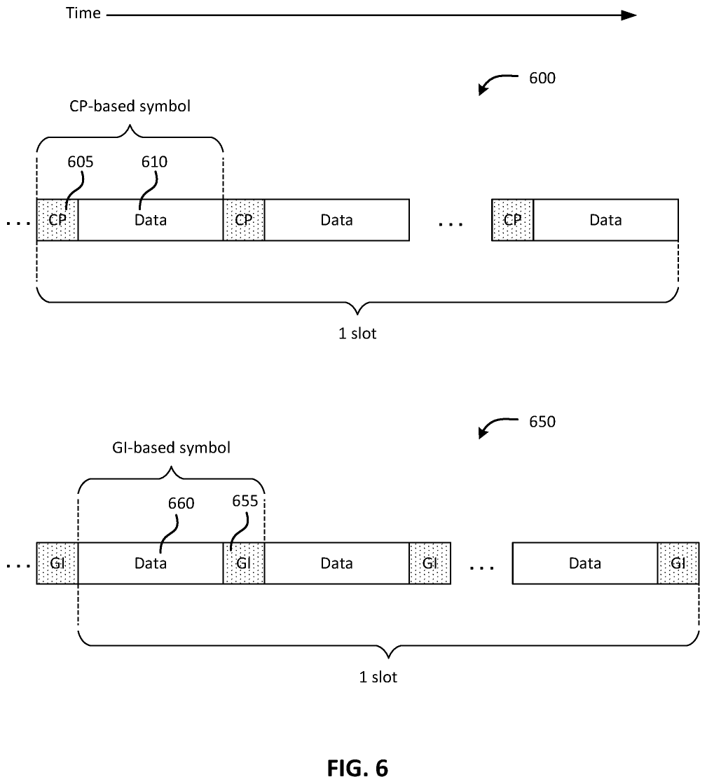

A guard interval (GI) offers much more flexibility than a CP. Because the length of a GI may not be fixed, it can be adaptable to different range spreads. Further, it can offer relatively low overhead to communication. (An additional comparison of GI to CP is described below, with respect to FIG. 6.) With these advantages in mind, embodiments herein incorporate a GI-based ISAC waveform to accommodate for various sensing needs, including some very stringent requirements. More specifically, embodiments herein describe various aspects of a GI-ISAC, including GI pattern and GI-ISAC waveform configuration parameters, GI-ISAC call flow with Tx parameter configuration transmission and Rx processing assistance information, sensing velocity and range information using the GI-ISAC waveform, and interference management handling. These aspects and others are described in more detail below.

FIG. 6 offers a comparison between traditional CP-based symbols (e.g., CP-OFDM) and GI-based symbols (e.g., GI-ISAC), according to an example. The first diagram 600 illustrates a traditional CP-based slot with a CP-based symbol comprising CP 605 and data 610. In traditional CP-OFDM, the data 610 may comprise an OFDM symbol. Further, one slot may comprise 14 OFDM symbols, each with a respective CP. As noted herein, the CPs for symbols (e.g., including CP 605) may have a fixed, or static length.

Diagram 650 shows an example GI-based slot, according to an embodiment. Similar to a CP-based symbol, a GI-based symbol includes of GI 655 (rather than a CP) and data 660. In this example, the GIs 655 follows the data 660, although this may not always be the case, as described in further detail below. Further, the duration of the GIs 655 is variable in length. According to some embodiments, it may be desirable to retain a static overall GI-based symbol length, so lengthening GI 655 may shorten data 660 and vice versa. Additional details regarding GI-based symbols, and GI-ISAC specifically, is provided below.

In implementation, a wireless device such as a UE, base station, or other sensing node capable of communications, may transmit a set of symbols that comprises both CP-OFDM communication data symbols and GI-ISAC symbols. Parameters defining the GI-ISAC (e.g., parameters of a GI-ISAC waveform codebook, which may be provided in a GI-ISAC configuration by a configuring device, as described in more detail below) may depend on the parameters of OFDM communication used for CP-OFDM communication. This can help minimize any impact on CP-OFDM communication when using GI-ISAC for RF sensing.

In one example, a GI-ISAC configuration may define a GI pattern for a coherent processing interval (CPI). This may include, for example, a CPI comprising one or more consecutive slots or mini-slots, a CPI depending on a carrier frequency, a CPI dependent on sensing quality of service (QOS) requirements (e.g., velocity estimation accuracy, range, etc.), or a combination thereof. Additionally or alternatively, a GI-ISAC configuration may define GI content within a CPI, such as zeros, a CP, or at least part of a sensing reference sequence. According to some embodiments, a GI-ISAC configuration additionally or alternatively may indicate a location (within a CPI) of the GI, such as which symbol(s) and/or whether the GI is located at the head (beginning) or tail (and) within a CPI. Additionally or alternatively, the GI-ISAC configuration may indicate a GI duration. According to some embodiments, this duration may be applicable to all locations where a GI is present within a CPI. In some embodiments, different durations may be applied to different GIs.

The use of a GI-ISAC in this manner can allow for RF sensing as well as compatibility with CP-OFDM communications. For example, an ISAC symbol may comprise an OFDM data sequence or a sensing symbol. In the case of a sensing symbol, the sensing symbol may be a linear frequency modulated (LFM) or non-linear frequency modulated (NLFM) waveform, for example, with parameters dependent on the CP-OFDM configuration, such as bandwidth (e.g., LFM and/or NLFM bandwidth) and symbol duration (e.g., LFM/NLFM chirp duration may be equal to or a function of symbol duration). Additionally or alternatively, the ISAC symbol may comprise RF sensing-centric communication data, such as phase-coded LFM.

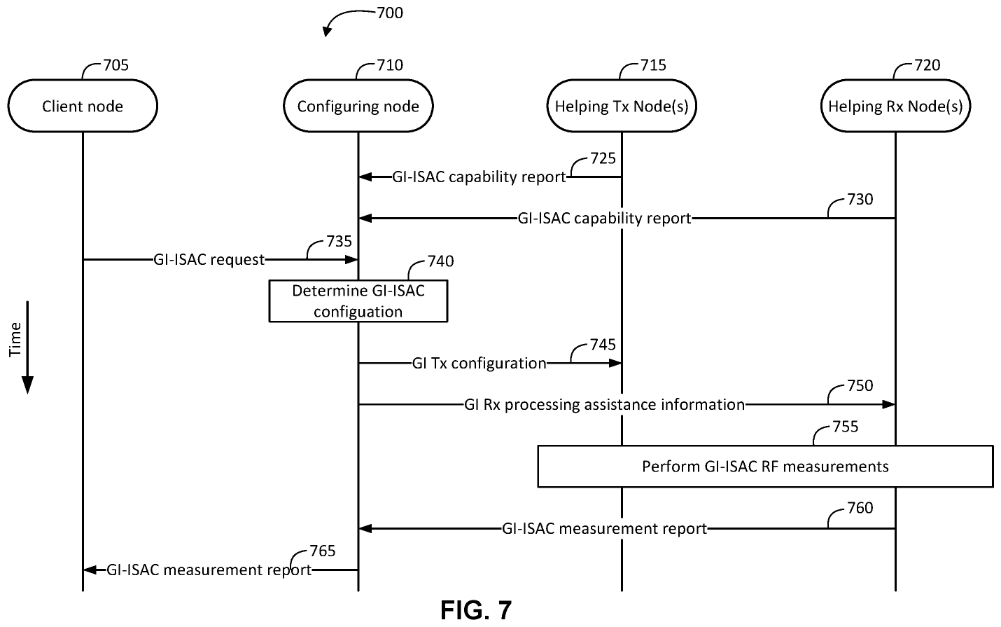

The configuration of the GI-ISAC may be determined and/or provided to one or more sensing nodes by a configuring node, which can operate as a centralized controller to coordinate the use of GI-ISAC by one or more sensing nodes. An example of how this may be done is provided in FIG. 7, described below.

FIG. 7 is a call flow diagram 700 illustrating an example process by which, according to some embodiments, a client node 705 can request and receive GI-ISAC measurement information obtained in an RF sensing process using GI-ISAC. Here, the process using GI-ISAC is coordinated by a configuring node 710 and executed by “helping” nodes 715 and 720. The client node 705 may comprise any device communicatively coupled with the configuring node 710, such as a UE. As noted above, the configuring node 710 may comprise a centralized controller such as a server (e.g., SnMF) or a base station (e.g., a main anchor gNB). The configuring node 710 may coordinate GI-ISAC operation of one or more helping Tx nodes 715 and/or one or more helping Rx nodes 720. Helping nodes 715 and 720 may comprise neighboring sensing nodes (e.g., UEs and/or base stations that are near enough to each other to send/receive RF signals between each other) that may be used for GI-ISAC communication and/or RF sensing. It can be noted that, although helping Tx node(s) 715 and helping Rx node(s) 720 are illustrated as separate nodes, embodiments are not so limited. According to some embodiments, one or more helping nodes may be used that perform the roles of both Tx and Rx nodes (e.g., operating in a monostatic configuration, or bistatic configurations in which the node transmits and receives). It may be further noted that, according to some embodiments, the process of diagram 700 may be incorporated into another configuration process, such as a process for RF sensing. In such embodiments, capability, configuration, and/or other such information may be communicated together with other information for performing an RF sensing procedure.

As illustrated by arrow 725 and 730, the process may begin with the configuring node 710 receiving capability reports with supported GIA Tx and Rx configuration patterns from neighboring helping nodes 715 and 720. More specifically, the helping Tx node(s) 715 may indicate what capabilities they have with respect to transmitting GI-ISAC waveforms (e.g., support for GI-ISAC, constraints and/or other parameters with respect to supported GI length, etc.) According to some embodiments, the capability reports provided at arrow 725 and 730 may be responsive to a request (not shown in FIG. 7) sent from the configuring node 710 to the helping nodes 715 and 720. According to some embodiments, such a request and/or the capability reports provided at arrow 725 and 730 may be responsive to one or more triggers. One example trigger may include a helping node (e.g., helping node 715 or 720) sending a capability report when it enters the coverage of a centralized controller (e.g., configuring node 710) and establishes link with the centralized controller, informing the centralized controller that the helping node is available to help with sensing functions. In another example, a centralized controller (e.g., configuring node 710) can send a “help” request (e.g., on an as-needed basis or periodically) to prospective helping nodes (e.g., nearby UEs) asking for the capability report, as well as possible sensing assistance.

According to some embodiments, neighboring helping nodes 715 and 720 may provide additional information to the configuring node 710. This can include, for example, location information of the helping nodes 715 and 720. Location information can, for example, allow the configuring node 710 to know which nodes may be in the vicinity of a client node 705 for purposes of GI-ISAC operation (e.g., sensing and/or communicating using GI-ISAC). Additionally, or alternatively, the configuring node 710 may obtain location information for one or more of the helping nodes 715 and 720 using other means.

As illustrated by arrow 735, the client node 705 can provide the configuring node 710 with a request for GI-ISAC operation. This request may be triggered, for example, by an application or function executed by the client node 705 requesting to perform RF sensing. Additionally or alternatively, the request at arrow 735 may be triggered by a request from another device (including a network node) for the client node 705 to perform RF sensing. The request at arrow 735 may include relevant information such as a requested or required QoS metric, which may be dependent on the application. For example, for embodiments in which the client node 705 may comprise or be incorporated into a vehicle may indicate a requested or required velocity resolution and/or maximum (and/or minimum) range to accommodate an automotive application (e.g., automated driving, driving assistance, etc.) executed at the client node 705.

As shown by block 740, the configuring node 710 may then determine a GI-ISAC configuration, which may be based at least in part on information received in the GI-ISAC request at arrow 735. For example, as noted above, GI-ISAC request may include a requested or required QoS metric. The configuring node 710 may then determine an appropriate GI-ISAC to accommodate this metric. As previously noted, the GI-ISAC configuration also may be determined based on OFDM (e.g., CP-OFDM) information used by the helping nodes 715 and 720. For example, in some instances, the GI-ISAC frame length (including the GI and the ISAC data) may conform with the frame length of CP-OFDM (including the CP and OFDM data), thereby enabling CP-OFDM transmissions within the GI-ISAC waveform.

As shown by arrow 745, the configuring node 710 may then provide the helping Tx node(s) 715 with a GI Tx configuration, reflective of the determined GI-ISAC at block 740. More specifically, the GI Tx configuration can enable the Tx node(s) 715 to transmit signals in accordance with the GI-ISAC waveform determined by the configuring node 710 at block 740, enabling ISAC RF sensing and/or communication. Similarly, the configuring node 710 may send the helping Rx node(s) 720 GI Rx processing assistance information, as shown at arrow 750. This information can enable the helping Rx node(s) 720 to process RF sensing and/or communication signals received using the GI-ISAC waveform. This GI-ISAC configuration information provided to the helping nodes 715 and 720 at arrows 745 and 750 may include the GI pattern (for a CPI) and/or GI-ISAC waveform configuration parameters described above.

As noted previously, it may be the case that only a portion of the helping Tx node(s) 715 and/or helping Rx node(s) 720 that provided capability reports at arrows 725 and 730 may comprise neighboring nodes that are capable of obtaining RF sensing information responsive to the GI-ISAC request at arrow 735. As such, the configuration information provided by the configuring node 710 at arrows 745 and 750 may be provided to a subset of the helping Tx node(s) 715 and helping Rx node(s) 720. (If that is the case, then only the subset(s) would perform the operations 755 and 760 shown in FIG. 7.)

At block 755, the helping Tx node(s) 715 and helping Rx node(s) 720 perform GI-ISAC RF measurements in accordance with the configuration information received at arrows 745 and 750. That is, the helping nodes 715 and 720 may perform an RF sensing procedure using the GI-ISAC waveform indicated in the configuration information received at arrows 745 and 750. In some aspects, the helping nodes 715 and 720 may be viewed as operating in a GI-ISAC mode, during which the RF sensing operation at block 755 is performed. Because of the ISAC functionality of the GI-ISAC waveform, the helping nodes 715 and 720 also may communicate (e.g., among each other) while in the GI-ISAC mode.

As shown by arrow 760, the helping Rx node(s) 720 may then provide a GI-ISAC measurement report to the configuring node 710, which may be indicative of GI-ISAC measurements performed at block 755. More specifically, these measurement reports from each of the helping Rx node(s) 720 may indicate RF sensing measurements made by each of the helping Rx node(s) 720, which may be indicative of the presence of one or more detected objects using RF sensing, and may further include information about the one or more objects (e.g., location, velocity, size, etc.). These measurement reports may be compiled and/or summarized by the configuring node 710, which may then provide a corresponding compiled/summarized GI-ISAC measurement report to the client node 705, as shown by arrow 765.

It can be noted that, in some configurations, the client node 705 and/or configuring node 710 may comprise a wireless device capable of operating in a GI-ISAC configuration. If the client node 705 has such capabilities, it may provide a capability report, receive GI-ISAC configuration information, and perform GI-ISAC RF measurements (e.g., as a Tx node and/or Rx node) in a manner similar to the process described above with respect to the helping nodes 715 and 720. If the configuring node 710 has such capabilities (e.g., comprises a base station), it may participate in the performance of GI-ISAC RF measurements as a Tx node and/or Rx node. Other variations to the example illustrated in FIG. 7 are contemplated, which may be dependent on the types of devices/notes capable of GI-ISAC functionality and available to participate in performing GI-ISAC RF measurements.

Various aspects of the process in FIG. 7 may allow for the flexible use of a GI-ISAC in a variety of applications. For example, in one case, an ISAC QoS for sensing (provided by the clients node 705 to the configuring node 710 at arrow 735) may include velocity estimation key performance indicators (KPIs) such as velocity resolution and large maximum unambiguous range. According to some embodiments, the GI-ISAC configuration determined at block 740 may include a CPI that is determined based on velocity and range KPIs from a set of available CPI configuration settings in a codebook. According to some embodiments, the GI-ISAC waveform may be used for range/velocity estimation for short-range sensing (e.g., performed at block 755 of FIG. 7) while communicating to another communication Rx node. According to some embodiments, the GI pattern used by the GI-ISAC configuration can include a sensing reference sequence with good correlation properties with a duration adapted to support a good target SNR and a low overhead to communication ratio. According to some embodiments, the GI may be adapted based on a range requirement to support long-range radar sensing. In such instances, the GI may be chosen as zeros with a duration adapted based on a range requirement.

The GI-ISAC waveform may flexibly accommodate other types of functionality. For example, the ISAC symbol can also comprise RF-sensing-centric communication data, such as phase-coded LFM or NLFM with a constant GI duration for each symbol within a CPI. The GI may comprise zeros, for example, and/or may comprise a constant partial sequence that, when combined with a remaining symbol part, enables a sensing waveform with good correlation properties.

In some embodiments, the ISAC symbol of the GI-ISAC waveform may comprise a sensing symbol, such as a LFM or NLFM waveform, whose parameters may be dependent on the CP-OFDM configuration. For example, an NLFM signal may be described by the following equation for instantaneous frequency:

$${F}_{i} ( t ) = \frac{t}{τ} ( {β}_{L} + {β}_{C} \frac{1}{\sqrt{1 - \frac{4 {t}^{2}}{{τ}^{2}}}} ) , \vert t \vert < \frac{τ}{2} \qquad ( Eqn . 1 )$$

This represents a hybrid LFM and NLFM waveform. Parameters of this equation, such as LFM bandwidth, β_{L}, and NLFM bandwidth, β_{C}, may be selected to ensure the sensing symbol is aligned with CP-OFDM, using the allocated resource bandwidth (e.g., N resource elements (REs)). Moreover, the NLFM signal may comprise multiple symbols with duration (τ=M CP-OFDM symbols).

It can be further noted that the configuring node 710 may provide GI-ISAC configuration information to nodes for purposes other than performing RF sensing for providing a GI-ISAC measurement report to a client node 705 (as indicated by the operations at block 755 and arrows 760 and 765). It can be used, for example, for interference cancellation. According to some embodiments, the configuring node 710 may provide other nodes (not shown in FIG. 7) operating in an ISAC mode with the GI configuration pattern (provided to the helping Tx node(s) 715 at arrow 745) for improved interference cancelation. For legacy nodes using CP-OFDM (also not shown in 5G. 7), the configuring node 710 may provide instructions for handling interference from the GI-ISAC waveforms. The legacy nodes could, for example, treat the GI-ISAC waveforms as noise with a variance that may be provided by the configuring node 710.

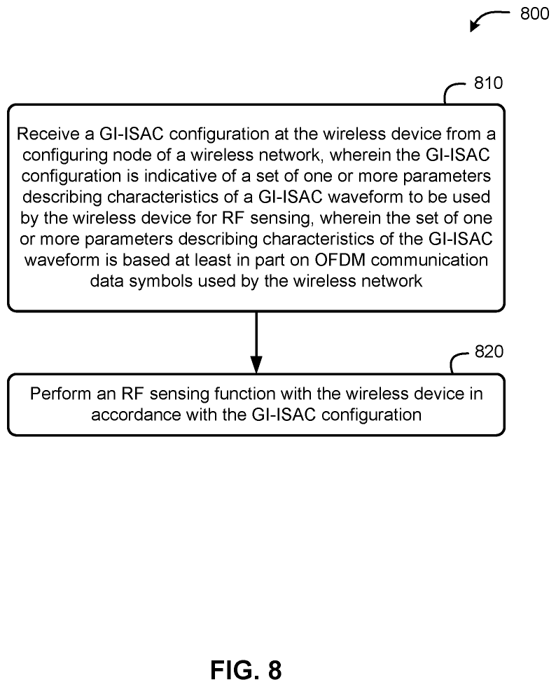

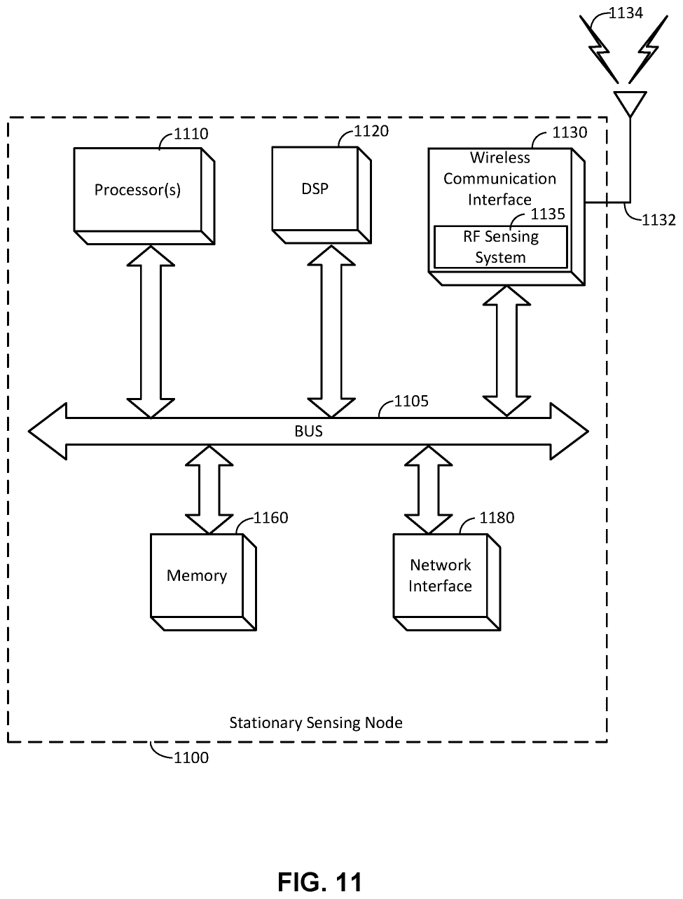

FIG. 8 is a flow diagram of a method 800 of performing integrated RF sensing and communications, according to an embodiment. The method 800 may be performed by a wireless device, such as a sensing node (e.g., a UE or base station of the wireless network) as described herein. Aspects of the method 800 may correspond with the functionality of helping node(s) 715 and/or 720 illustrated in FIG. 7. The operations of method 800 may be performed by software and/or hardware components of a sensing node, and examples of such components are illustrated in FIGS. 10 and 11, described below.

At block 810, the functionality comprises receiving a GI-ISAC configuration at the wireless device from a configuring node of a wireless network, wherein the GI-ISAC configuration is indicative of a set of one or more parameters describing characteristics of a GI-ISAC waveform to be used by the wireless device for RF sensing, wherein the set of one or more parameters describing characteristics of the GI-ISAC waveform is based at least in part on OFDM communication data symbols used by the wireless network. As noted herein, parameters may describe frequency (e.g., bandwidth) or timing (e.g., symbol) characteristics that may be based on OFDM (e.g., CP-OFDM) communication data symbols. The functionality at block 810 may correspond with the functionality at arrows 745 and/or 750 of FIG. 7, described above.

According to some embodiments, the set of one or more parameters describing characteristics of the GI-ISAC waveform defines a GI pattern of the GI-ISAC waveform. As noted in the embodiments described herein, the GI pattern may include a coherent processing interval (CPI), GI content within a CPI, one or more GI locations within a CPI, a duration of a GI, or any combination thereof. In some embodiments in which the GI pattern includes the CPI, the CPI comprises one or more consecutive slots/mini-slots, the CPI is determined based at least in part on carrier frequency, the CPI is determined based at least in part on a sensing quality of service (QoS) metric, or any combination thereof. In such embodiments, the CPI may be determined based at least in part on the sensing QoS metric. Further, the sensing QoS metric may comprise a velocity resolution, a maximum range, or both. Additionally, or alternatively, the GI pattern may include the GI content within the CPI. In such embodiments, the GI content may comprise only zeros, a CP, or at least a portion of a sensing reference sequence.

As noted herein, GI-ISAC waveforms may incorporate OFDM (e.g., CP-OFDM) waveforms. As such, according to some embodiments of the method 800, the GI-ISAC waveform may comprise an ISAC symbol comprising an OFDM data sequence or a sensing symbol. In such embodiments, the ISAC symbol may comprise the sensing symbol, where the sensing symbol may comprise an LFM or NLFM waveform whose characteristics are dependent on a CP-OFDM configuration.

As described in the embodiments herein, some embodiments may provide for the GI-ISAC configuration to be based at least in part on capability information provided by the wireless device. For example, some embodiments may include, prior to receiving the GI-ISAC configuration, sending a capability report indicative of one or more capabilities of the wireless device for generating the GI-ISAC waveform to perform the RF sensing function.

Means and/or structure for performing the functionality at block 810 may include a bus 1005, one or more processors 1010, a digital signal processor (DSP) 1020, a wireless communication interface 1030 (which may include an RF sensing system 1035), one or more memories 1060, and/or other components of a mobile sensing node 1000 as illustrated in FIG. 10 and described below. Additionally, or alternatively, means and/or structure for performing the functionality at block 810 may include a bus 1105, one or more processors 1110, a DSP 1120, a wireless communication interface 1130 (which may include an RF sensing system 1135), one or more memories 1060, and/or other components of a stationary sensing node 1100 as illustrated in FIG. 11 and described below.

The functionality at block 820 comprises performing an RF sensing function with the wireless device in accordance with the GI-ISAC configuration. The functionality at block 920 may correspond with the functionality block 755 of FIG. 7, for example. The way in which the RF sensing function is performed may vary, depending on whether the wireless device is transmitting or receiving RF sensing signals (or both). For example, in some embodiments, performing the RF sensing function may comprise transmitting an RF signal with the GI-ISAC waveform, receiving an RF signal with the GI-ISAC waveform, or both. According to some embodiments, performing the RF sensing function may comprise receiving the RF signal with the GI-ISAC waveform, performing a measurement of the received RF signal, and sending a report indicative of the measurement to the configuring node.

Means and/or structure for performing the functionality at block 820 may include a bus 1005, one or more processors 1010, a digital signal processor (DSP) 1020, a wireless communication interface 1030 (which may include an RF sensing system 1035), one or more memories 1060, and/or other components of a mobile sensing node 1000 as illustrated in FIG. 10 and described below. Additionally, or alternatively, means and/or structure for performing the functionality at block 820 may include a bus 1105, one or more processors 1110, a DSP 1120, a wireless communication interface 1130 (which may include an RF sensing system 1135), one or more memories 1060, and/or other components of a stationary sensing node 1100 as illustrated in FIG. 11 and described below.

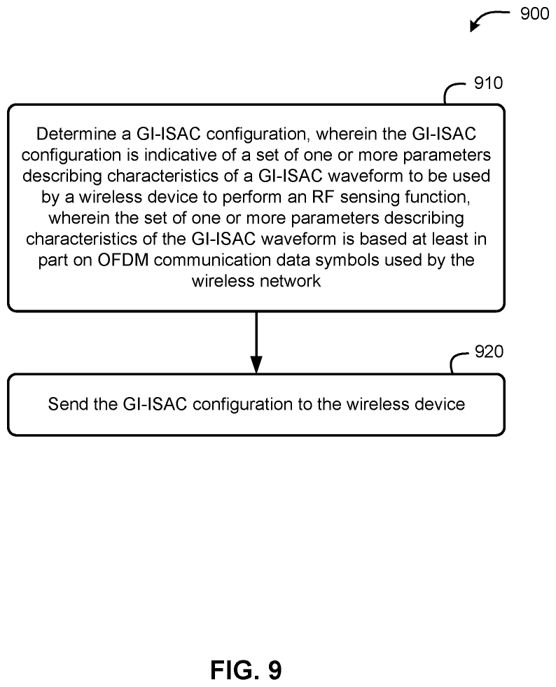

FIG. 9 is a flow diagram of a method 900 of enabling integrated RF sensing and communications, according to an embodiment. The method 900 may be performed by a configuring node, such as a base station or server (or other centralized controller) of a wireless network, as described herein. Aspects of the method 900 may correspond with the functionality of configuring node 710 illustrated in FIG. 7. The operations of method 900 may be performed by software and/or hardware components of a computing device, and examples of such components are illustrated in 5G. 12, described below.

At block 910, the functionality comprises determining a GI-ISAC configuration, wherein the GI-ISAC configuration is indicative of a set of one or more parameters describing characteristics of a GI-ISAC waveform to be used by a wireless device to perform an RF sensing function, wherein the set of one or more parameters describing characteristics of the GI-ISAC waveform is based at least in part on OFDM communication data symbols used by the wireless network. Again, parameters may describe frequency (e.g., bandwidth) or timing (e.g., symbol) characteristics that may be based on OFDM (e.g., CP-OFDM) communication data symbols. The functionality at block 910 may correspond with the functionality at block 740 of FIG. 7, described above.

According to some embodiments, the set of one or more parameters describing characteristics of the GI-ISAC waveform defines a GI pattern of the GI-ISAC waveform. As noted in the embodiments described herein, the GI pattern may include a coherent processing interval (CPI), GI content within a CPI, one or more GI locations within a CPI, a duration of a GI, or any combination thereof. In some embodiments in which the GI pattern includes the CPI, the CPI comprises one or more consecutive slots/mini-slots, the CPI is determined based at least in part on carrier frequency, the CPI is determined based at least in part on a sensing quality of service (QoS) metric, or any combination thereof. In such embodiments, the CPI may be determined based at least in part on the sensing QoS metric. Further, the sensing QoS metric may comprise a velocity resolution, a maximum range, or both. Additionally, or alternatively, the GI pattern may include the GI content within the CPI. In such embodiments, the GI content may comprise only zeros, a CP, or at least a portion of a sensing reference sequence.

As noted herein, GI-ISAC waveforms may incorporate OFDM (e.g., CP-OFDM) waveforms. As such, according to some embodiments of the method 900, the GI-ISAC waveform may comprise an ISAC symbol comprising an OFDM data sequence or a sensing symbol. In such embodiments, the ISAC symbol may comprise the sensing symbol, where the sensing symbol may comprise an LFM or NLFM waveform whose characteristics are dependent on a CP-OFDM configuration.

As described in the embodiments herein, some embodiments may provide for the GI-ISAC configuration to be based at least in part on capability information provided by the wireless device. For example, some embodiments may include, prior to receiving the GI-ISAC configuration, receiving a capability report at the configuring node, the capability report indicative of one or more capabilities of the wireless device for generating the GI-ISAC waveform to perform the RF sensing function, wherein the set of one or more parameters describing characteristics of the GI-ISAC waveform is further based at least in part on the one or more capabilities of the wireless device for generating the GI-ISAC waveform. This and functionality may correspond with the functionality shown by arrows 725 and 730 of FIG. 7.

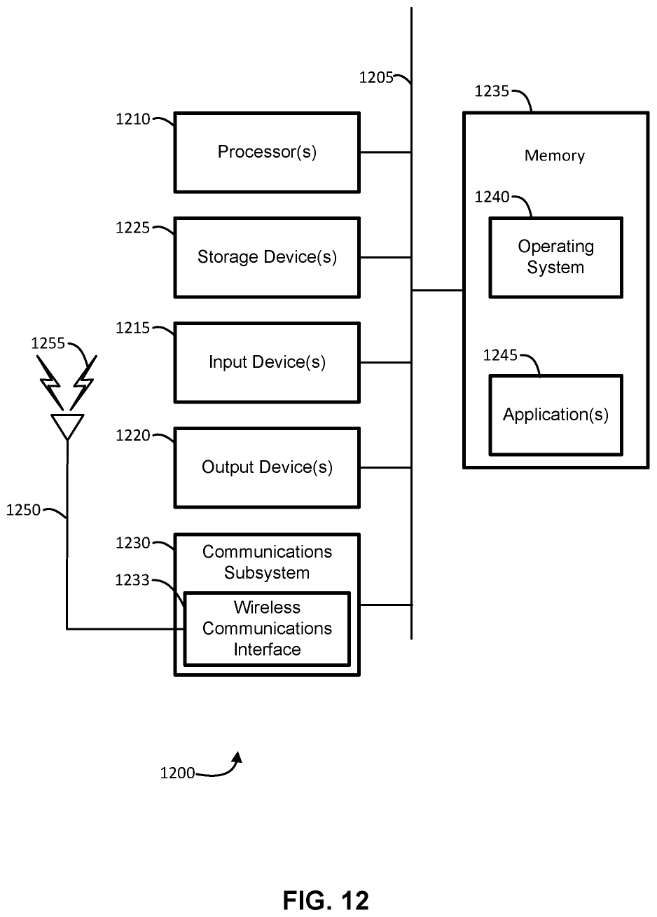

Means and/or structure for performing the functionality at block 910 may include a bus 1205, one or more processors 1210, one or more storage devices 1225, a communications subsystem 1230 (which may include a wireless communications interface 1233), one or more memories 1235, and/or other components of a using system 1200 as illustrated in FIG. 12 and described below.

The functionality at block 920 comprises performing an RF sensing function with the wireless device in accordance with the GI-ISAC configuration. The functionality at block 920 may correspond with the functionality block 755 of FIG. 7, for example. The way in which the RF sensing function is performed may vary, depending on whether the wireless device is transmitting or receiving RF sensing signals (or both). For example, in some embodiments, performing the RF sensing function may comprise transmitting an RF signal with the GI-ISAC waveform, receiving an RF signal with the GI-ISAC waveform, or both. According to some embodiments, performing the RF sensing function may comprise receiving the RF signal with the GI-ISAC waveform, performing a measurement of the received RF signal, and sending a report indicative of the measurement to the configuring node.

Means and/or structure for performing the functionality at block 910 may include a bus 1205, one or more processors 1210, one or more storage devices 1225, a communications subsystem 1230 (which may include a wireless communications interface 1233), one or more memories 1235, and/or other components of a using system 1200 as illustrated in FIG. 12 and described below.

FIG. 10 is a block diagram of an embodiment of a mobile sensing node 1000, which can be utilized as described herein. For example, mobile sensing node 1000 may correspond to a mobile device (e.g., mobile device 105 of FIG. 1), UE (e.g., UE 205 of FIG. 2), node (e.g., node(s) 1 and/or 2 of FIG. 4, client node 705, helping nodes 715 and/or 720 of FIG. 7), or the like, as described herein. Further, as described below, the mobile sensing node 1000 may implement an RF sensing system 1035, which may correspond to the RF sensing system 305 described above with respect to FIG. 3. Moreover, according to some embodiments, a mobile sensing node 1000 may function as a configuring node or device, as described herein, in some scenarios. As such, the mobile sensing node 1000 may be capable of performing some or all of the functionality described in the methods regarding sensing nodes and/or configuring nodes as described herein. It should be noted that FIG. 10 is meant only to provide a generalized illustration of various components, any or all of which may be utilized as appropriate.

The mobile sensing node 1000 is shown comprising hardware elements that can be electrically coupled via a bus 1005 (or may otherwise be in communication, as appropriate). The hardware elements may include a processor(s) 1010 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 1010 may comprise one or more processing units, which may be housed in a single integrated circuit (IC) or multiple ICs. As shown in FIG. 10, some embodiments may have a separate DSP 1020, depending on desired functionality. Location determination and/or other determinations based on wireless communication may be provided in the processor(s) 1010 and/or wireless communication interface 1030 (discussed below). The mobile sensing node 1000 also can include one or more input devices 1070, which can include without limitation one or more keyboards, touch screens, touch pads, microphones, buttons, dials, switches, and/or the like; and one or more output devices 1015, which can include without limitation one or more displays (e.g., touch screens), light emitting diodes (LEDs), speakers, and/or the like.

The mobile sensing node 1000 may also include a wireless communication interface 1030, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the mobile sensing node 1000 to communicate and/or perform positioning with other devices as described in the embodiments above, with respect to WLAN and/or cellular technologies. The wireless communication interface 1030 may permit data and signaling to be communicated (e.g., transmitted and received) with NG-RAN nodes of a network, for example, via eNBs, gNBs, ng-eNBs, access points, NTN satellites, various base stations, TRPs, and/or other access node types, and/or other network components, computer systems, and/or any other electronic devices communicatively coupled with TRPs, as described herein. The communication can be carried out via one or more wireless communication antenna(s) 1032 that send and/or receive wireless signals 1034. According to some embodiments, the wireless communication antenna(s) 1032 may comprise a plurality of discrete antennas, antenna arrays, or any combination thereof. The antenna(s) 1032 may be capable of transmitting and receiving wireless signals using beams (e.g., Tx beams and Rx beams). Beam formation may be performed using digital and/or analog beam formation techniques, with respective digital and/or analog circuitry. The wireless communication interface 1030 may include such circuitry.

As noted above, the mobile sensing node 1000 may implement an RF sensing system 1035. The RF sensing system 1035 may comprise the hardware and/or software elements described above with respect to FIG. 3. As illustrated in FIG. 10 and noted above, some or all of the RF sensing system 1035 may be implemented within a wireless communication interface 1030, which may utilize certain components for both communication and RF sensing. That said, embodiments are not so limited. Alternative embodiments may implement some or all of the RF sensing system 1035 separate from the wireless communication interface 1030 (e.g., in cases where RF sensing may utilize different frequencies and/or different hardware/software components than the wireless communication interface 1030).

Depending on desired functionality, the wireless communication interface 1030 may comprise a separate receiver and transmitter, or any combination of transceivers, transmitters, and/or receivers to communicate with base stations (e.g., ng-eNBs and gNBs) and other terrestrial transceivers, such as wireless devices and access points, as well as NTN satellites. The mobile sensing node 1000 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The mobile sensing node 1000 can further include sensor(s) 1040. Sensor(s) 1040 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information. As noted in the description above, sensors 1040 may be used, for example, to determine a velocity of the mobile sensing node, which may be reported to a configuring device, according to some embodiments.

Embodiments of the mobile sensing node 1000 may also include a Global Navigation Satellite System (GNSS) receiver 1080 capable of receiving signals 1084 from one or more GNSS satellites using an antenna 1082 (which could be the same as antenna 1032). Positioning based on GNSS signal measurement can be utilized to complement and/or incorporate the techniques described herein. The GNSS receiver 1080 can extract a position of the mobile sensing node 1000, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS), and/or the like. Moreover, the GNSS receiver 1080 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1080 is illustrated in FIG. 10 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 1010, DSP 1020, and/or a processor within the wireless communication interface 1030 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 1010 or DSP 1020.

The mobile sensing node 1000 may further include and/or be in communication with a memory 1060. The memory 1060 can include, without limitation, local and/or network accessible storage, a disk drive, a drive array, an optical storage device, a solid-state storage device, such as a random-access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1060 of the mobile sensing node 1000 also can comprise software elements (not shown in FIG. 10), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1060 that are executable by the mobile sensing node 1000 (and/or processor(s) 1010 or DSP 1020 within mobile sensing node 1000). In some embodiments, then, such code and/or instructions can be used to configure and/or adapt a general-purpose computer (or other device) to perform one or more operations in accordance with the described methods.

FIG. 11 is a block diagram of an embodiment of a stationary sensing node 1100, which can be utilized as described herein. For example, stationary sensing node 1100 may correspond to a base station or access node (e.g., base station 100 of FIG. 1 and/or access nodes 210, 214, and 216 of FIG. 2), node (e.g., node(s) 1 and/or 2 of FIG. 4, client node 705, configuring node 710, helping nodes 715 and/or 720 of FIG. 7) or the like, as described herein. Further, as described below, the stationary sensing node 1100 may implement an RF sensing system 1135, which may correspond to the RF sensing system 305 described above with respect to FIG. 3. Moreover, according to some embodiments, a stationary sensing node 1100 may function as a configuring node or device, as described herein, in some scenarios. As such, the stationary sensing node 1100 may be capable of performing some or all of the functionality described in the methods regarding sensing nodes and/or configuring nodes as described herein. It should be noted that FIG. 11 is meant only to provide a generalized illustration of various components, any or all of which may be utilized as appropriate. In some embodiments, the stationary sensing node 1100 may correspond to a gNB, an ng-eNB, and/or (more generally) a TRP and/or base station, as previously noted. In some cases, a stationary sensing node 1100 may comprise multiple TRPs—e.g. with each TRP associated with a different antenna or a different antenna array of the stationary sensing node 1100 (e.g., 1132). As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP.

The functionality performed by a stationary sensing node 1100 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. The functionality of these functional components may be performed by one or more of the hardware and/or software components illustrated in FIG. 11.

The stationary sensing node 1100 is shown comprising hardware elements that can be electrically coupled via a bus 1105 (or may otherwise be in communication, as appropriate). The hardware elements may include a processor(s) 1110 which can include without limitation one or more general-purpose processors, one or more special-purpose processors (such as digital signal processor (DSP) chips, graphics acceleration processors, application-specific integrated circuits (ASICs), and/or the like), and/or other processing structure or means. As shown in FIG. 11, some embodiments may have a separate DSP 1120, depending on desired functionality. Location determination and/or other determinations based on wireless communication may be provided in the processor(s) 1110 and/or wireless communication interface 1130 (discussed below), according to some embodiments. The stationary sensing node 1100 also can include one or more input devices, which can include without limitation a keyboard, display, mouse, microphone, button(s), dial(s), switch(es), and/or the like; and one or more output devices, which can include without limitation a display, light emitting diode (LED), speakers, and/or the like.

The stationary sensing node 1100 might also include a wireless communication interface 1130, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, cellular communication facilities, etc.), and/or the like, which may enable the stationary sensing node 1100 to communicate as described herein. The wireless communication interface 1130 may permit data and signaling to be communicated (e.g., transmitted and received) to UEs, other base stations/TRPs (e.g., eNBs, gNBs, and ng-eNBs), and/or other network components, computer systems, and/or other electronic devices described herein. The communication can be carried out via one or more wireless communication antenna(s) 1132 that send and/or receive wireless signals 1134. According to some embodiments, one or more wireless communication antenna(s) 1132 may comprise one or more antenna arrays, which may be capable of beamforming.

As noted above, the stationary sensing node 1100 may implement an RF sensing system 1135. The RF sensing system 1135 may comprise the hardware and/or software elements described above with respect to FIG. 3. As illustrated in FIG. 11 and noted above, some or all of the RF sensing system 1135 may be implemented within a wireless communication interface 1130, which may utilize certain components for both communication and RF sensing. That said, embodiments are not so limited. Alternative embodiments may implement some or all of the RF sensing system 1135 separate from the wireless communication interface 1130 (e.g., in cases where RF sensing may utilize different frequencies and/or different hardware/software components then the wireless communication interface 1130).

The stationary sensing node 1100 may also include a network interface 1180, which can include support of wireline communication technologies. The network interface 1180 may include a modem, network card, chipset, and/or the like. The network interface 1180 may include one or more input and/or output communication interfaces to permit data to be exchanged with a network, communication network servers, computer systems, and/or any other electronic devices described herein.

In many embodiments, the stationary sensing node 1100 may further comprise a memory 1160. The memory 1160 can include, without limitation, local and/or network accessible storage, a disk drive, a drive array, an optical storage device, a solid-state storage device, such as a random-access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1160 of the stationary sensing node 1100 also may comprise software elements (not shown in FIG. 11), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1160 that are executable by the stationary sensing node 1100 (and/or processor(s) 1110 or DSP 1120 within stationary sensing node 1100). In some embodiments, then, such code and/or instructions can be used to configure and/or adapt a general-purpose computer (or other device) to perform one or more operations in accordance with the described methods.

FIG. 12 is a block diagram of an embodiment of a computer system 1200, which may be used, in whole or in part, to provide the functions of one or more components and/or devices as described in the embodiments herein. The computer system 1200, for example, may be utilized within and/or executed by a server (e.g., location server/LMF or sensing server/SnMF) or base station/TRP (e.g., gNB), which may perform the functions of a configuring node (e.g., configuring node 710 of FIG. 7) as described herein. It should be noted that FIG. 12 is meant only to provide a generalized illustration of various components, any or all of which may be utilized as appropriate. FIG. 12, therefore, broadly illustrates how individual system elements may be implemented in a relatively separated or relatively more integrated manner. In addition, it can be noted that components illustrated by FIG. 12 can be localized to a single device and/or distributed among various networked devices, which may be disposed at different geographical locations.

The computer system 1200 is shown comprising hardware elements that can be electrically coupled via a bus 1205 (or may otherwise be in communication, as appropriate). The hardware elements may include processor(s) 1210, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1200 also may comprise one or more input devices 1215, which may comprise without limitation a mouse, a keyboard, a camera, a microphone, and/or the like; and one or more output devices 1220, which may comprise without limitation a display device, a printer, and/or the like.

The computer system 1200 may further include (and/or be in communication with) one or more non-transitory storage devices 1225, which can comprise, without limitation, local and/or network accessible storage, and/or may comprise, without limitation, a disk drive, a drive array, an optical storage device, a solid-state storage device, such as a random-access memory (RAM) and/or read-only memory (ROM), which can be programmable, flash-updateable, and/or the like. Such storage devices may be configured to implement any appropriate data stores, including without limitation, various file systems, database structures, and/or the like. Such data stores may include database(s) and/or other data structures used to store and administer messages and/or other information to be sent to one or more devices via hubs, as described herein.

The computer system 1200 may also include a communications subsystem 1230, which may comprise wireless communication technologies managed and controlled by a wireless communication interface 1233, as well as wired technologies (such as Ethernet, coaxial communications, universal serial bus (USB), and the like). The wireless communication interface 1233 may comprise one or more wireless transceivers that may send and receive wireless signals 1255 (e.g., signals according to 5G NR or LTE) via wireless antenna(s) 1250. Thus the communications subsystem 1230 may comprise a modem, a network card (wireless or wired), an infrared communication device, a wireless communication device, and/or a chipset, and/or the like, which may enable the computer system 1200 to communicate on any or all of the communication networks described herein to any device on the respective network, including UE, base stations and/or other transmission reception points (TRPs), satellites, and/or any other electronic devices described herein. Hence, the communications subsystem 1230 may be used to receive and send data as described in the embodiments herein.

In many embodiments, the computer system 1200 will further comprise a working memory 1235, which may comprise a RAM or ROM device, as described above. Software elements, shown as being located within the working memory 1235, may comprise an operating system 1240, device drivers, executable libraries, and/or other code, such as one or more applications 1245, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1225 described above. In some cases, the storage medium might be incorporated within a computer system, such as computer system 1200. In other embodiments, the storage medium might be separate from a computer system (e.g., a removable medium, such as an optical disc), and/or provided in an installation package, such that the storage medium can be used to program, configure, and/or adapt a general-purpose computer with the instructions/code stored thereon. These instructions might take the form of executable code, which is executable by the computer system 1200 and/or might take the form of source and/or installable code, which, upon compilation and/or installation on the computer system 1200 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description, embodiments may include different combinations of features. Implementation examples are described in the following numbered clauses:

Clause 1: A method at a wireless device of performing integrated radio frequency (RF) sensing and communications, the method comprising: receiving a guard interval integrated sensing and communications (GI-ISAC) configuration at the wireless device from a configuring node of a wireless network, wherein the GI-ISAC configuration is indicative of a set of one or more parameters describing characteristics of a GI-ISAC waveform to be used by the wireless device for RF sensing, wherein the set of one or more parameters describing characteristics of the GI-ISAC waveform is based at least in part on orthogonal frequency division multiplexing (OFDM) communication data symbols used by the wireless network; and performing an RF sensing function with the wireless device in accordance with the GI-ISAC configuration.

Clause 2: The method of clause 1, wherein the set of one or more parameters describing characteristics of the GI-ISAC waveform defines a guard interval (GI) pattern of the GI-ISAC waveform, wherein the GI pattern includes: a coherent processing interval (CPI), GI content within a CPI, one or more GI locations within a CPI, a duration of a GI, or any combination thereof.

Clause 3: The method of clause 2, wherein the GI pattern includes the CPI, and wherein: the CPI comprises one or more consecutive slots/mini-slots, the CPI is determined based at least in part on carrier frequency, the CPI is determined based at least in part on a sensing quality of service (QoS) metric, or any combination thereof.

Clause 4: The method of any one of clauses 2-3, wherein the CPI is determined based at least in part on the sensing QoS metric, and wherein the sensing QoS metric comprises: a velocity resolution, a maximum range, or both.

Clause 5: The method of any one of clauses 2-4, wherein the GI pattern includes the GI content within the CPI, and wherein the GI content comprises: only zeros, a cyclic prefix (CP), or at least a portion of a sensing reference sequence.

Clause 6: The method of any one of clauses 2-5, wherein the GI-ISAC waveform comprises an integrated sensing and communications (ISAC) symbol comprising an OFDM data sequence or a sensing symbol.

Clause 7: The method of clause 6, wherein the ISAC symbol comprises the sensing symbol, the sensing symbol comprises a linear frequency-modulated (LFM) waveform or non-linear frequency-modulated (NLFM) waveform whose characteristics are dependent on a CP-OFDM configuration.

Clause 8: The method of any one of clauses 1-7, further comprising, prior to receiving the GI-ISAC configuration, sending a capability report indicative of one or more capabilities of the wireless device for generating the GI-ISAC waveform to perform the RF sensing function.

Clause 9: The method of any one of clauses 1-8, wherein performing the RF sensing function comprises transmitting an RF signal with the GI-ISAC waveform, receiving an RF signal with the GI-ISAC waveform, or both.

Clause 10: The method of clause 9, wherein performing the RF sensing function comprises: receiving the RF signal with the GI-ISAC waveform; performing a measurement of the received RF signal; and sending a report indicative of the measurement to the configuring node.

Clause 11: The method of any one of clauses 1-10, wherein the wireless device comprises a user equipment (UE) or a base station.

Clause 12: A method at a configuring node of a wireless network of enabling integrated radio frequency (RF) sensing and communications, the method comprising: determining a guard interval integrated sensing and communications (GI-ISAC) configuration, wherein the GI-ISAC configuration is indicative of a set of one or more parameters describing characteristics of a GI-ISAC waveform to be used by a wireless device to perform an RF sensing function, wherein the set of one or more parameters describing characteristics of the GI-ISAC waveform is based at least in part on orthogonal frequency division multiplexing (OFDM) communication data symbols used by the wireless network; and sending the GI-ISAC configuration to the wireless device.

Clause 13: The method of clause 12, wherein the set of one or more parameters describing characteristics of the GI-ISAC waveform defines a guard interval (GI) pattern of the GI-ISAC waveform, wherein the GI pattern includes: a coherent processing interval (CPI), GI content within a CPI, one or more GI locations within a CPI, a duration of a GI, or any combination thereof.

Clause 14: The method of clause 13, wherein the GI pattern includes the CPI, and wherein: the CPI comprises one or more consecutive slots/mini-slots, the CPI is determined based at least in part on carrier frequency, the CPI is determined based at least in part on a sensing quality of service (QoS) metric, or any combination thereof.

Clause 15: The method of any one of clauses 13-14, wherein the CPI is determined based at least in part on the sensing QoS metric, and wherein the sensing QoS metric comprises: a velocity resolution, a maximum range, or both.

Clause 16: The method of any one of clauses 13-15, wherein the GI pattern includes the GI content within the CPI, and wherein the GI content comprises: only zeros, a cyclic prefix (CP), or at least a portion of a sensing reference sequence.

Clause 17: The method of any one of clauses 12-16, wherein the GI-ISAC waveform comprises an integrated sensing and communications (ISAC) symbol comprising an OFDM data sequence or a sensing symbol.

Clause 18: The method of clause 17, wherein: the ISAC symbol comprises the sensing symbol, the sensing symbol comprises a linear frequency-modulated (LFM) waveform or non-linear frequency-modulated (NLFM) waveform whose characteristics are dependent on a CP-OFDM configuration.

Clause 19: The method of any one of clauses 12-18, further comprising, prior to determining the GI-ISAC configuration, receiving a capability report at the configuring node, the capability report indicative of one or more capabilities of the wireless device for generating the GI-ISAC waveform to perform the RF sensing function, wherein the set of one or more parameters describing characteristics of the GI-ISAC waveform is further based at least in part on the one or more capabilities of the wireless device for generating the GI-ISAC waveform.

Clause 20: The method of any one of clauses 12-19, wherein the configuring node comprises a base station or server of the wireless network.

Clause 21: A wireless device for performing integrated radio frequency (RF) sensing and communications, the wireless device comprising: one or more transceivers; one or more memories; and one or more processors communicatively coupled with the one or more transceivers and the one or more memories, the one or more processors configured to: receive a guard interval integrated sensing and communications (GI-ISAC) configuration at the wireless device from a configuring node of a wireless network, wherein the GI-ISAC configuration is indicative of a set of one or more parameters describing characteristics of a GI-ISAC waveform to be used by the wireless device for RF sensing, wherein the set of one or more parameters describing characteristics of the GI-ISAC waveform is based at least in part on orthogonal frequency division multiplexing (OFDM) communication data symbols used by the wireless network; and perform an RF sensing function using the one or more transceivers in accordance with the GI-ISAC configuration.

Clause 22: The wireless device of clause 21, wherein the set of one or more parameters describing characteristics of the GI-ISAC waveform defines a guard interval (GI) pattern of the GI-ISAC waveform, wherein the GI pattern includes: a coherent processing interval (CPI), GI content within a CPI, one or more GI locations within a CPI, a duration of a GI, or any combination thereof.

Clause 23: The wireless device of either of clauses 21 or 22, wherein the GI-ISAC waveform comprises an integrated sensing and communications (ISAC) symbol comprising an OFDM data sequence or a sensing symbol.

Clause 24: The wireless device of any one of clauses 21-23, wherein the one or more processors are configured to, prior to receiving the GI-ISAC configuration, send a capability report indicative of one or more capabilities of the wireless device for generating the GI-ISAC waveform to perform the RF sensing function.

Clause 25: The wireless device of any one of clauses 21-24, wherein, to perform the RF sensing function, the one or more processors are configured to transmit an RF signal with the GI-ISAC waveform, receive an RF signal with the GI-ISAC waveform, or both.

Clause 26: The wireless device of any one of clauses 21-25, wherein the wireless device comprises a user equipment (UE) or a base station.

Clause 27: A configuring node of a wireless network, the configuring node comprising: one or more transceivers; one or more memories; and one or more processors communicatively coupled with the one or more transceivers and the one or more memories, the one or more processors configured to: determine a guard interval integrated sensing and communications (GI-ISAC) configuration, wherein the GI-ISAC configuration is indicative of a set of one or more parameters describing characteristics of a GI-ISAC waveform to be used by a wireless device to perform an radio frequency (RF) sensing function, wherein the set of one or more parameters describing characteristics of the GI-ISAC waveform is based at least in part on orthogonal frequency division multiplexing (OFDM) communication data symbols used by the wireless network; and send the GI-ISAC configuration to the wireless device via the one or more transceivers.

Clause 28: The configuring node of clause 27, wherein the set of one or more parameters describing characteristics of the GI-ISAC waveform defines a guard interval (GI) pattern of the GI-ISAC waveform, wherein the GI pattern includes: a coherent processing interval (CPI), GI content within a CPI, one or more GI locations within a CPI, a duration of a GI, or any combination thereof.

Clause 29: The configuring node of either of clauses 27 or 28, wherein the one or more processors are further configured to, prior to determining the GI-ISAC configuration, receive a capability report at the configuring node, the capability report indicative of one or more capabilities of the wireless device for generating the GI-ISAC waveform to perform the RF sensing function, wherein one or more processors are further configured to base the set of one or more parameters describing characteristics of the GI-ISAC waveform at least in part on the one or more capabilities of the wireless device for generating the GI-ISAC waveform.

Clause 30: The configuring node of any one of clauses 27-29, wherein the configuring node comprises a base station or server of the wireless network.

Clause 31: An apparatus having means for performing the method of any one of clauses 1-20.

Clause 32: A non-transitory computer-readable medium storing instructions, the instructions comprising code for performing the method of any one of clauses 1-20.

What is claimed is:

1. A method at a wireless device of performing integrated radio frequency (RF) sensing and communications, the method comprising:
receiving a guard interval integrated sensing and communications (GI-ISAC) configuration at the wireless device from a configuring node of a wireless network, wherein the GI-ISAC configuration is indicative of a set of one or more parameters describing characteristics of a GI-ISAC waveform to be used by the wireless device for RF sensing, wherein the set of one or more parameters describing characteristics of the GI-ISAC waveform is based at least in part on orthogonal frequency division multiplexing (OFDM) communication data symbols used by the wireless network; and
performing an RF sensing function with the wireless device in accordance with the GI-ISAC configuration.

2. The method of claim 1, wherein the set of one or more parameters describing characteristics of the GI-ISAC waveform defines a guard interval (GI) pattern of the GI-ISAC waveform, wherein the GI pattern includes:
a coherent processing interval (CPI),
GI content within a CPI,
one or more GI locations within a CPI,
a duration of a GI, or
any combination thereof.

3. The method of claim 2, wherein the GI pattern includes the CPI, and wherein:
the CPI comprises one or more consecutive slots/mini-slots,
the CPI is determined based at least in part on carrier frequency,
the CPI is determined based at least in part on a sensing quality of service (QoS) metric, or
any combination thereof.

4. The method of claim 3, wherein the CPI is determined based at least in part on the sensing QoS metric, and wherein the sensing QoS metric comprises:
a velocity resolution,
a maximum range, or
both.

5. The method of claim 2, wherein the GI pattern includes the GI content within the CPI, and wherein the GI content comprises:
only zeros,
a cyclic prefix (CP), or
at least a portion of a sensing reference sequence.

6. The method of claim 1, wherein the GI-ISAC waveform comprises an integrated sensing and communications (ISAC) symbol comprising an OFDM data sequence or a sensing symbol.

7. The method of claim 6, wherein the ISAC symbol comprises the sensing symbol, the sensing symbol comprises a linear frequency-modulated (LFM) waveform or non-linear frequency-modulated (NLFM) waveform whose characteristics are dependent on a CP-OFDM configuration.

8. The method of claim 1, further comprising, prior to receiving the GI-ISAC configuration, sending a capability report indicative of one or more capabilities of the wireless device for generating the GI-ISAC waveform to perform the RF sensing function.

9. The method of claim 1, wherein performing the RF sensing function comprises transmitting an RF signal with the GI-ISAC waveform, receiving an RF signal with the GI-ISAC waveform, or both.

10. The method of claim 9, wherein performing the RF sensing function comprises:
receiving the RF signal with the GI-ISAC waveform;
performing a measurement of the received RF signal; and
sending a report indicative of the measurement to the configuring node.

11. The method of claim 1, wherein the wireless device comprises a user equipment (UE) or a base station.

12. A method at a configuring node of a wireless network of enabling integrated radio frequency (RF) sensing and communications, the method comprising:
determining a guard interval integrated sensing and communications (GI-ISAC) configuration, wherein the GI-ISAC configuration is indicative of a set of one or more parameters describing characteristics of a GI-ISAC waveform to be used by a wireless device to perform an RF sensing function, wherein the set of one or more parameters describing characteristics of the GI-ISAC waveform is based at least in part on orthogonal frequency division multiplexing (OFDM) communication data symbols used by the wireless network; and
sending the GI-ISAC configuration to the wireless device.

13. The method of claim 12, wherein the set of one or more parameters describing characteristics of the GI-ISAC waveform defines a guard interval (GI) pattern of the GI-ISAC waveform, wherein the GI pattern includes:
a coherent processing interval (CPI),
GI content within a CPI,
one or more GI locations within a CPI,
a duration of a GI, or
any combination thereof.

14. The method of claim 13, wherein the GI pattern includes the CPI, and wherein:
the CPI comprises one or more consecutive slots/mini-slots,
the CPI is determined based at least in part on carrier frequency,
the CPI is determined based at least in part on a sensing quality of service (QoS) metric, or
any combination thereof.

15. The method of claim 14, wherein the CPI is determined based at least in part on the sensing QoS metric, and wherein the sensing QoS metric comprises:
a velocity resolution,
a maximum range, or
both.

16. The method of claim 13, wherein the GI pattern includes the GI content within the CPI, and wherein the GI content comprises:
only zeros,
a cyclic prefix (CP), or
at least a portion of a sensing reference sequence.

17. The method of claim 12, wherein the GI-ISAC waveform comprises an integrated sensing and communications (ISAC) symbol comprising an OFDM data sequence or a sensing symbol.

18. The method of claim 17, wherein:
the ISAC symbol comprises the sensing symbol, the sensing symbol comprises a linear frequency-modulated (LFM) waveform or non-linear frequency-modulated (NLFM) waveform whose characteristics are dependent on a CP-OFDM configuration.

19. The method of claim 12, further comprising, prior to determining the GI-ISAC configuration, receiving a capability report at the configuring node, the capability report indicative of one or more capabilities of the wireless device for generating the GI-ISAC waveform to perform the RF sensing function, wherein the set of one or more parameters describing characteristics of the GI-ISAC waveform is further based at least in part on the one or more capabilities of the wireless device for generating the GI-ISAC waveform.

20. The method of claim 12, wherein the configuring node comprises a base station or server of the wireless network.

21. A wireless device for performing integrated radio frequency (RF) sensing and communications, the wireless device comprising:
one or more transceivers;
one or more memories; and
one or more processors communicatively coupled with the one or more transceivers and the one or more memories, the one or more processors configured to:
receive a guard interval integrated sensing and communications (GI-ISAC) configuration at the wireless device from a configuring node of a wireless network, wherein the GI-ISAC configuration is indicative of a set of one or more parameters describing characteristics of a GI-ISAC waveform to be used by the wireless device for RF sensing, wherein the set of one or more parameters describing characteristics of the GI-ISAC waveform is based at least in part on orthogonal frequency division multiplexing (OFDM) communication data symbols used by the wireless network; and
perform an RF sensing function using the one or more transceivers in accordance with the GI-ISAC configuration.

22. The wireless device of claim 21, wherein the set of one or more parameters describing characteristics of the GI-ISAC waveform defines a guard interval (GI) pattern of the GI-ISAC waveform, wherein the GI pattern includes:
a coherent processing interval (CPI),
GI content within a CPI,
one or more GI locations within a CPI,
a duration of a GI, or
any combination thereof.

23. The wireless device of claim 21, wherein the GI-ISAC waveform comprises an integrated sensing and communications (ISAC) symbol comprising an OFDM data sequence or a sensing symbol.

24. The wireless device of claim 21, wherein the one or more processors are configured to, prior to receiving the GI-ISAC configuration, send a capability report indicative of one or more capabilities of the wireless device for generating the GI-ISAC waveform to perform the RF sensing function.

25. The wireless device of claim 21, wherein, to perform the RF sensing function, the one or more processors are configured to transmit an RF signal with the GI-ISAC waveform, receive an RF signal with the GI-ISAC waveform, or both.

26. The wireless device of claim 21, wherein the wireless device comprises a user equipment (UE) or a base station.

27. A configuring node of a wireless network, the configuring node comprising:
one or more transceivers;
one or more memories; and
one or more processors communicatively coupled with the one or more transceivers and the one or more memories, the one or more processors configured to:
determine a guard interval integrated sensing and communications (GI-ISAC) configuration, wherein the GI-ISAC configuration is indicative of a set of one or more parameters describing characteristics of a GI-ISAC waveform to be used by a wireless device to perform an radio frequency (RF) sensing function, wherein the set of one or more parameters describing characteristics of the GI-ISAC waveform is based at least in part on orthogonal frequency division multiplexing (OFDM) communication data symbols used by the wireless network; and
send the GI-ISAC configuration to the wireless device via the one or more transceivers.

28. The configuring node of claim 27, wherein the set of one or more parameters describing characteristics of the GI-ISAC waveform defines a guard interval (GI) pattern of the GI-ISAC waveform, wherein the GI pattern includes:
a coherent processing interval (CPI),
GI content within a CPI,
one or more GI locations within a CPI,
a duration of a GI, or
any combination thereof.

29. The configuring node of claim 27, wherein the one or more processors are further configured to, prior to determining the GI-ISAC configuration, receive a capability report at the configuring node, the capability report indicative of one or more capabilities of the wireless device for generating the GI-ISAC waveform to perform the RF sensing function, wherein one or more processors are further configured to base the set of one or more parameters describing characteristics of the GI-ISAC waveform at least in part on the one or more capabilities of the wireless device for generating the GI-ISAC waveform.

30. The configuring node of claim 27, wherein the configuring node comprises a base station or server of the wireless network.
